(19) United States
(12) Patent Application Publication
(10) Pub. No.: US 2019/0116786 A1
(43) Pub. Date: Apr. 25, 2019

(54) CONTROLLED RELEASE FORMULATIONS OF HERBICIDES

(71) Applicant: HICAP FORMULATIONS LTD., Nottingham (GB)

(72) Inventors: Michael W. Burnet, Tubingen (DE); Jan-Hinrich Guse, Tubingen-Buhl (DE); Martin Reisser, Esslingen (DE)

(21) Appl. No.: 15/979,352

(22) Filed: May 14, 2018

Related U.S. Application Data
(63) Continuation of application No. 15/031,137, filed on Apr. 21, 2016, now abandoned.
(60) Provisional application No. 61/893,884, filed on Oct. 21, 2013.

(51) Int. Cl. A01N 25/12; A01N 43/80; A01N 25/34; A01N 33/20; A01N 25/08; A01N 43/50; A01N 43/653; A01N 25/10; A01N 37/22

(52) U.S. Cl. CPC A01N 25/12; A01N 43/80; A01N 25/34; A01N 33/20; A01N 37/22; A01N 43/50; A01N 43/653; A01N 25/10; A01N 25/08

(57) ABSTRACT

Disclosed are granular formulations of herbicides that provide a means to apply non-selective herbicides to field and paddy crops and turf. Granules can be formulated with sub-particles to allow differential release of one or other active ingredient. Granules or sub-particles allow for controlled release of active ingedient such that while up to 30% of the active ingredient is available within 24 h, the remainder requires 3 to 40 days to become available. Sub-particles may also be used as conventional sprays to reduce uptake by leaves of desirable crops.

### RELATED APPLICATIONS

This application is a continuation of U.S. application Ser. No. 15/031,137 filed Apr. 21, 2016, which application is the National Phase under 35 U.S.C. § 371 of PCT International Application No. PCT/IB2014/002982, filed Oct. 21, 2014, which claims the benefit of and priority to U.S. Provisional Application No. 61/893,884, filed Oct. 21, 2013, the contents of which are incorporated herein by reference.

### BACKGROUND ART

A key aspect of successful herbicide use in agriculture and turf is the delivery of agents in such a way as to minimise damage to the desired plants while maximising weed control. In field crops, this can mean placing the herbicide in soil layers above where the crop germinates. Rice culture may involve large amounts of water. Standing paddy or irrigation water can provide a means to distribute herbicide to weeds. Turf is similarly well irrigated and differential tolerance can be obtained by formulation for uptake via roots.

Herbicides may be applied to crops and turf conveniently in the form of granules and most manufacturers have opted for granule forms that disperse quickly so as to maximise the distribution of an agent in water.

Certain herbicides are known to be selective in rice because of inherent tolerance factors in rice such as differential metabolism. Other herbicides are not tolerated by rice when applied as sprays, yet their use would be advantageous given that many such herbicides are highly active on key weeds of rice. Similar observations can be made for turf, sugarcane, cereals and legumes such as soybeans. The herbicides sulfentrazone, carfentrazone and clomazone are examples of such herbicides. Both are unsuitable for spray applications to transplanted rice, soybeans or wheat because of limited tolerance.

Increasing the tolerance of rice, cereals, beans, sugarcane or turf grasses to additional herbicides may be achieved by genetic engineering, use of safening compounds, or by modifying the delivery or placement of the herbicide such that contact to desired plants is minimised.

### SUMMARY

Disclosed are granule or microgranule formulations of mixtures of herbicides including sulfentrazone, carfentrazone, sulfonylureas and clomazone, comprising a granule, one or more sub-particles containing active ingredients, an adhesive or mixture of adhesives, solubility modulators, surfactants, salts, and one or more herbicides or pesticides. The granules are distinguished in that they are designed to exhibit differential release of the pesticide components such that herbicides with limited selectivity in the target crop may be better tolerated through slower exposure, or via a different route of exposure. In particular, the granules contain sub-components that are distributed by the granule after it disintegrates, the subcomponents having specific composition designed to facilitate the controlled availability of a pesticide that they contain.

### BACKGROUND TO THE INVENTION

Traditional spray application of herbicides to an established crop and infesting weeds results in the direct contact of the spray solution to the crop plants. Typically, the herbicide or pesticide is formulated to maximize its availability. Only where this herbicide is well tolerated by the crop is the approach successful.

Application of herbicide in the form of granules has the advantage that the granule contacts the soil rather than the leaves of the crop. Once the granule reaches the soil surface, it should disperse to contact a wider area. To avoid excess concentrations of herbicide in one place, release of herbicide should be later, after dispersal. Packaging the herbicide into smaller sub-components allows for the dispersal of the sub-component prior to release of the herbicide more widely, this leads to a higher dispersal of the herbicide.

This concept of having two or more components in a formulation to mediate the availability of mixtures of compounds can be implemented in various instances. One concerns the use of safening compounds where the safener needs to enter the plant to be protected first, where it stimulates defense systems, afterwhich, the herbicide may enter with lower risk of harming the desired plant.

In another embodiment, one may formulate a mixture of a safe selective herbicide and a less safe non-selective herbicide. In this instance, the selective herbicide is formulated to be freely available, while the non-selective herbicide is formulated within a separate sub-particle in which it exhibits delayed release kinetics.

Applying the same principle to spray applications, this means that one herbicide is free in solution or suspension, while the other is in particles that are small enough to be distributed in water sprays, but retain the pesticide after application such that it is not immediately available to a leaf, but rather either falls to the ground after drying, or breaks down slowly to release the pesticide contained.

### BRIEF DESCRIPTION OF THE DRAWINGS

FIG. 1: Formulation of Sulfentrazone in PMMA on Biodac.

FIG. 2: Formulation of Sulfentrazone in Collodium on Vermiculite.

FIG. 3: Extraction of Sulfentrazone in paraffin oil on Biodac

FIG. 4: Extraction of Sulfentrazone in Polystyrene on Calcium carbonate

FIG. 5: Release of Sulfentrazone in PEG modified Acetylcellulose

FIG. 6: Extraction of Sulfentrazone and Clomazone in PEG-modified Acetylcellulose (064)

FIG. 7: Extraction of Sulfentrazone with PEG modified Acetylcellulose and addition of a Surfactant (068).

FIG. 8: Extraction of Sulfentrazone in Urotropin modified Acetylcellulose

FIG. 9: Extraction profile of solid film formulated by adding 7 g CaCO3 to a mixture of 0.61 g PMMA, 0.15 g PEG 8000, 0.24 g Sulfentrazone dissolved in 9 ml CHCl3/Acetone (1/1).

FIG. 10: Sulfentrazone extraction from Formulation A

FIG. 11: Sulfentrazone extraction from Formulation C

FIG. 12: Sulfentrazone extraction from Formulation F

FIG. 13: Sulfentrazone extraction from Formulation D

FIG. 14: Extraction profile of mixtures of PMMA, PEG 8000 and Sulfentrazone.

FIG. 15: Extraction profile of mixtures of PMMA, PEG 8000 and Sulfentrazone.

FIG. 16: Extraction profile of mixtures of PMMA, PEG 8000 and Sulfentrazone.

FIG. 17: Sulfentrazone extraction

FIG. 18: Sulfentrazone extraction

FIG. 19: Release profile of entry 11 (JG08029a)

FIG. 20: Release profile of entry 12 (JG08029b)

FIG. 21: Release profile of entry 13 (JG08029c)

FIG. 22: Release profile of entry 14 (JG08031d)

FIG. 23: Release profile of entry 15 (JG08031e)

FIG. 24: Release profile of entry 16 (JG08031f)

FIG. 25: Solution profile of Sulfentrazone

FIG. 26: Formulation of Sulfentrazone in acetyl cellulose for use in granule application. Sulfentrazone is Herbicide A. Herbicide B is either halosulfuron or bispyribac-sodium

FIG. 27: Sulfentrazone tolerance testing in rice.

FIG. 28: Release profile of Example 8 (JG08031 a)

FIG. 29: Release profile of example 9 (JG08031b)

FIG. 30: Release profile of Example 10 (JG08031c)

FIG. 31: Reduction of phytotoxicity of carfentrazone using a sulfonylurea.

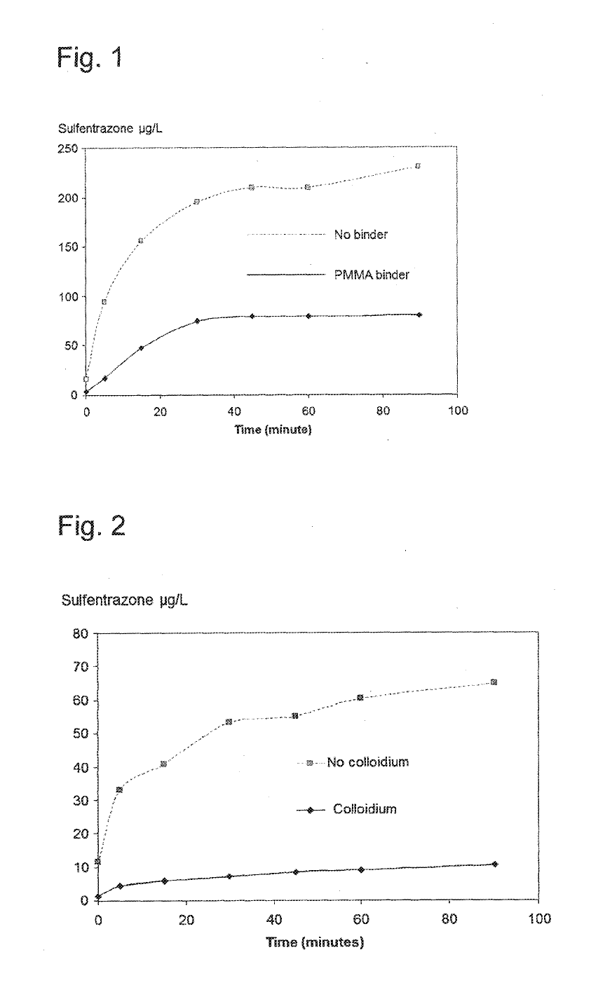

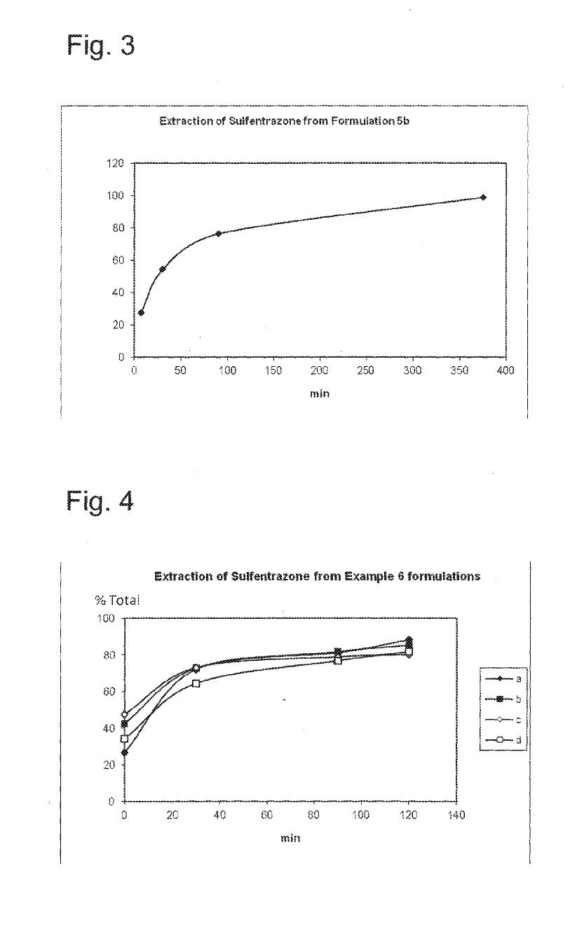

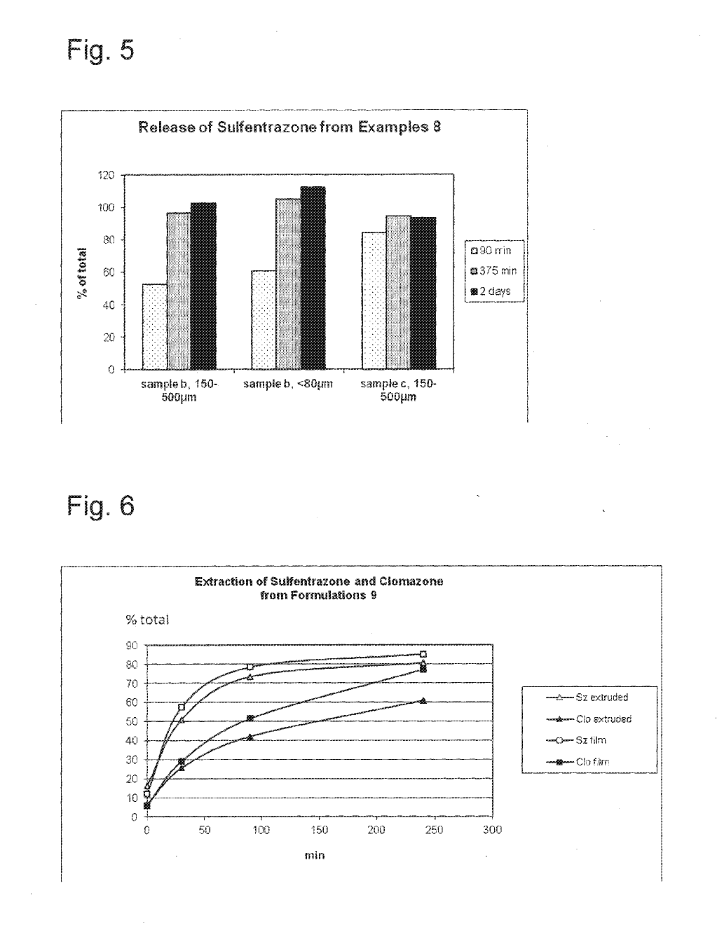

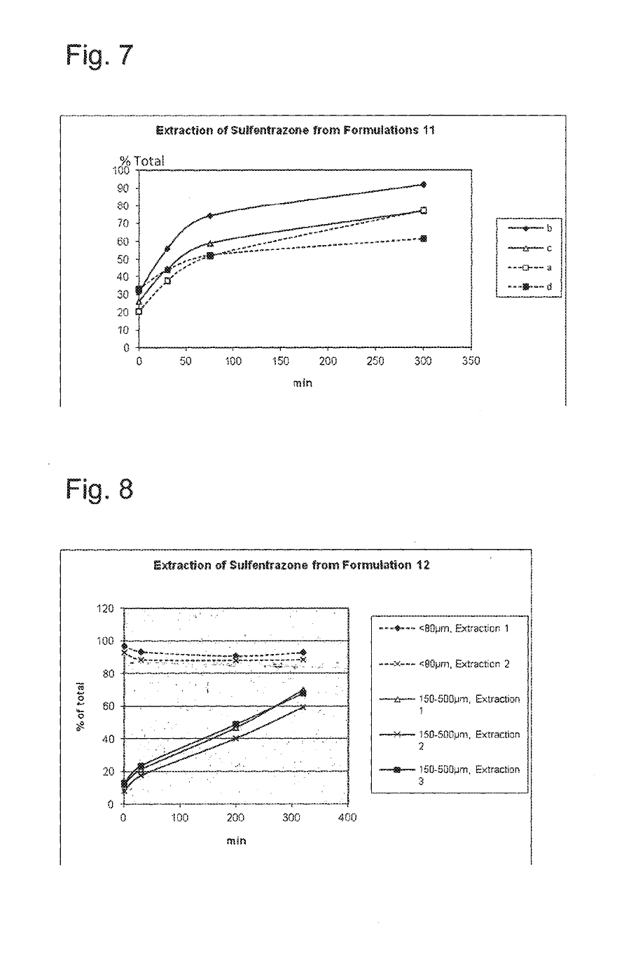

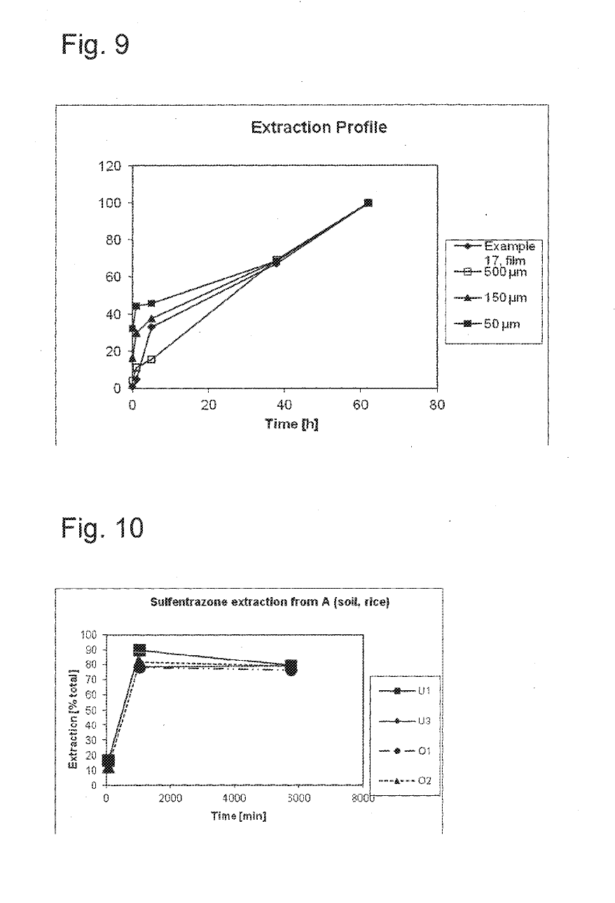

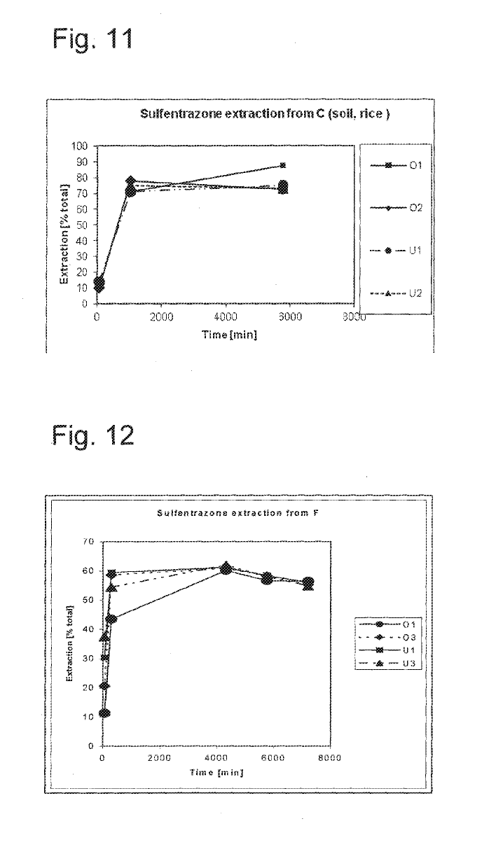

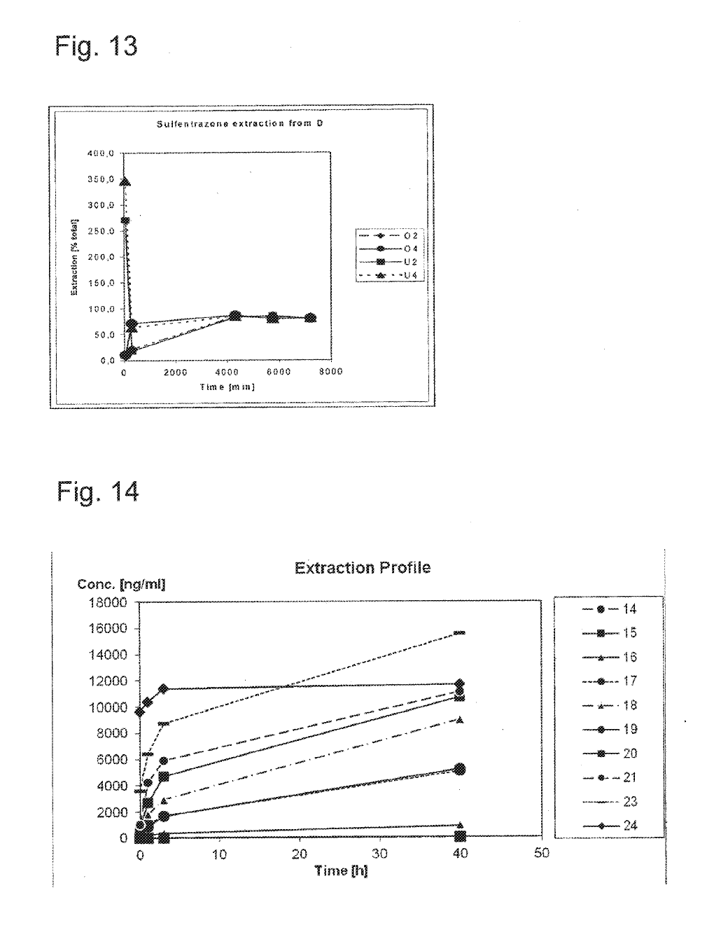

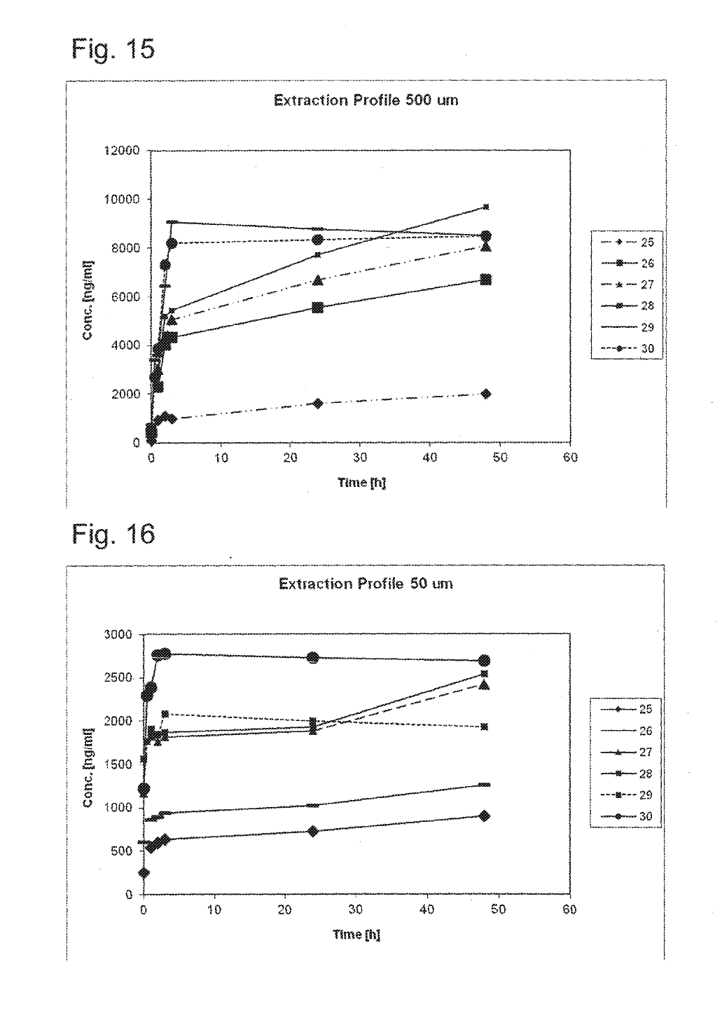

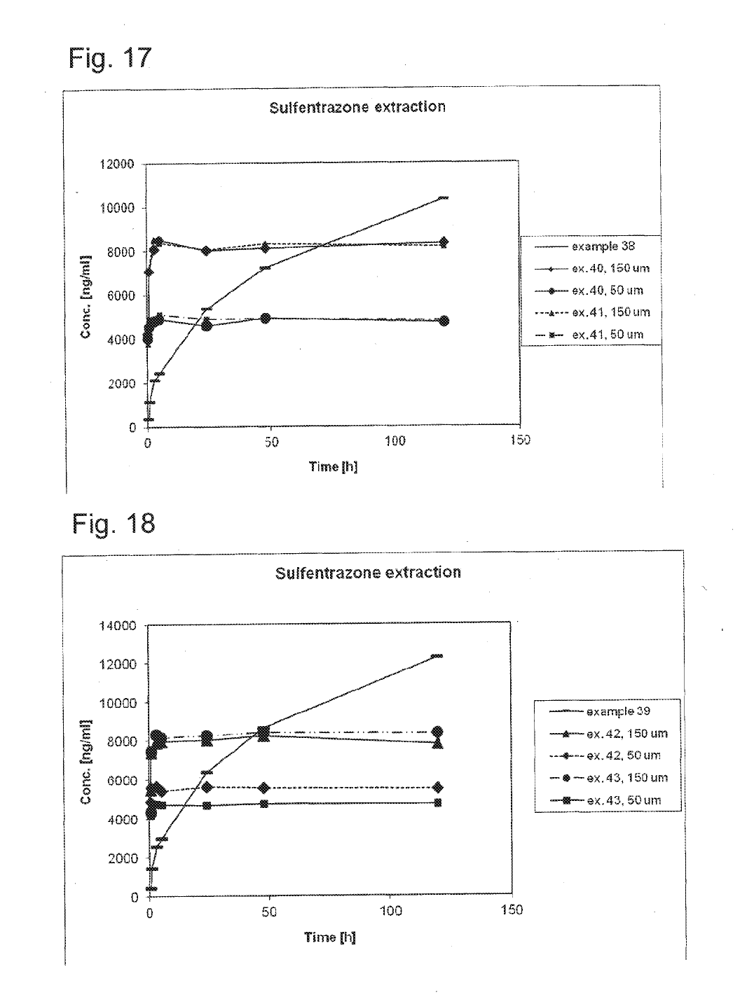

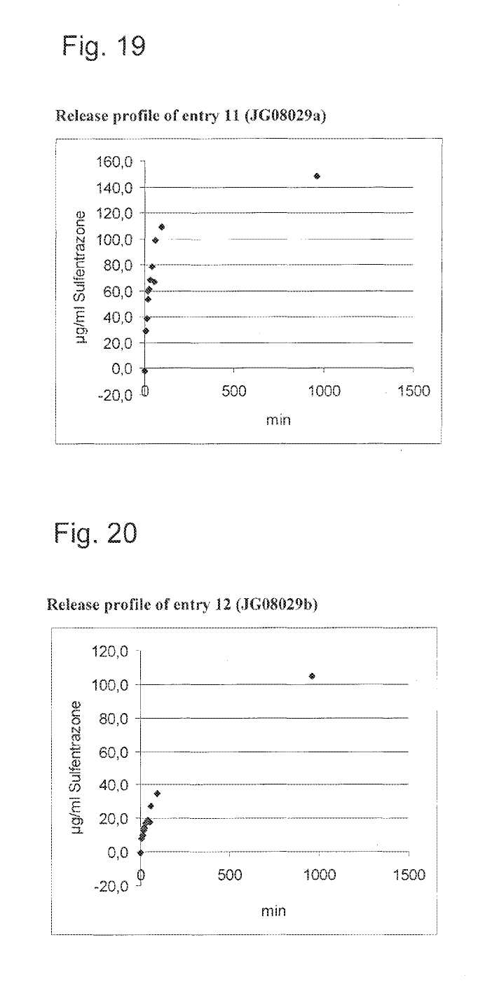

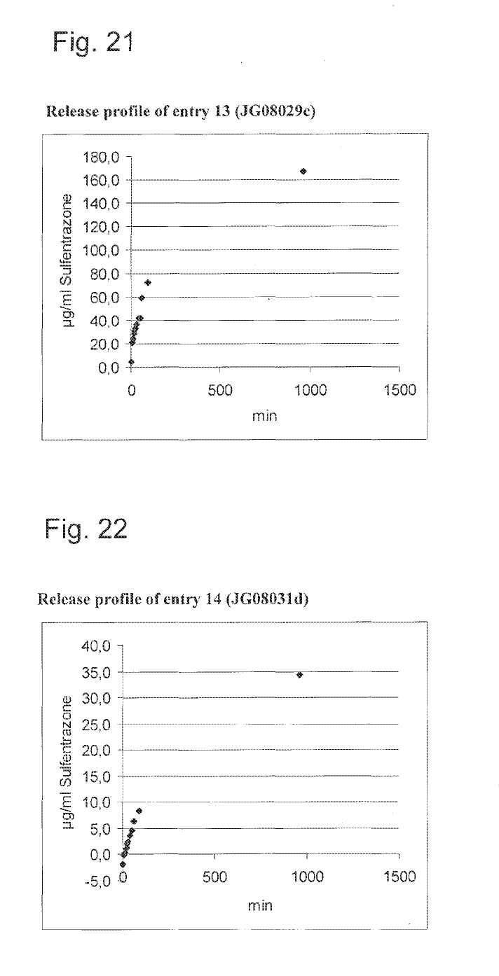

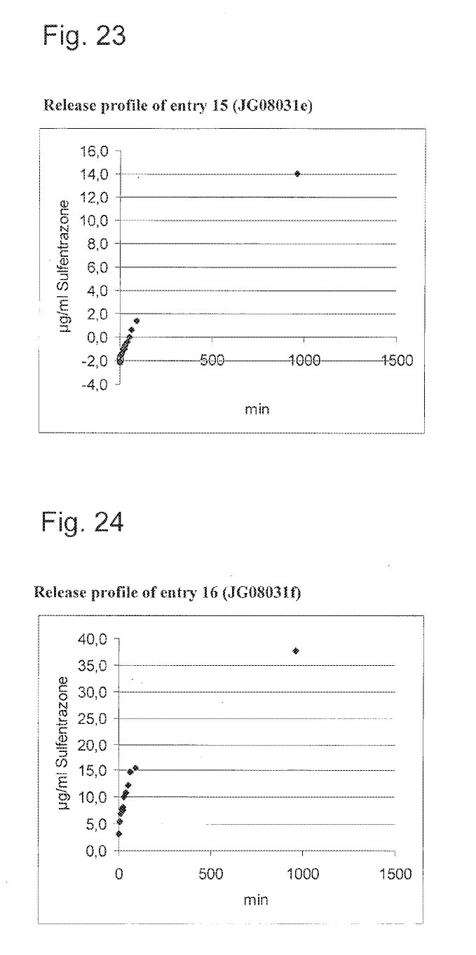

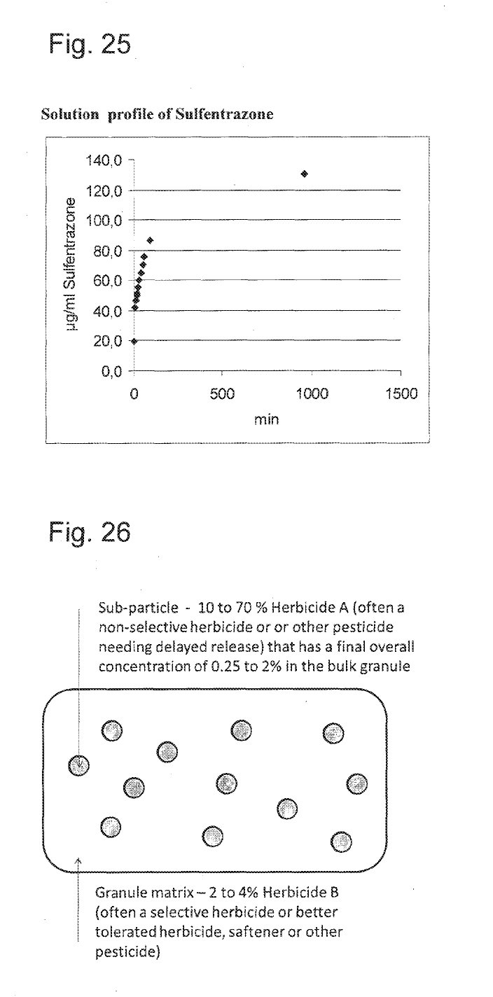

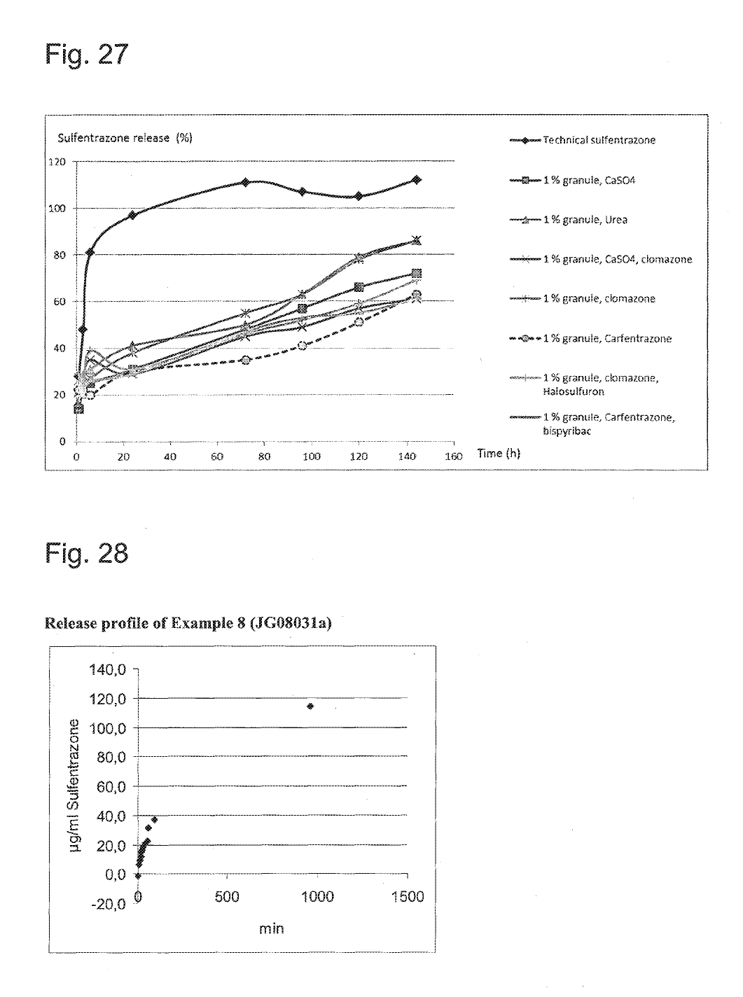

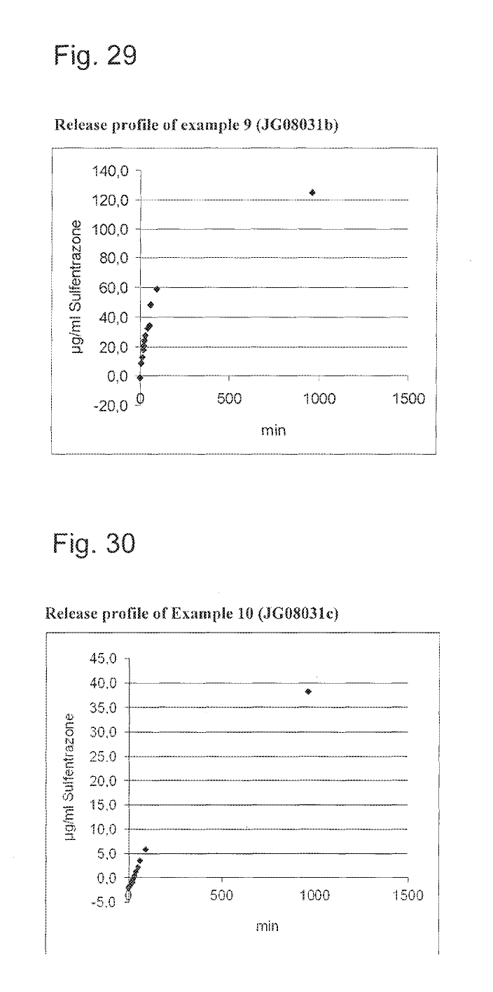

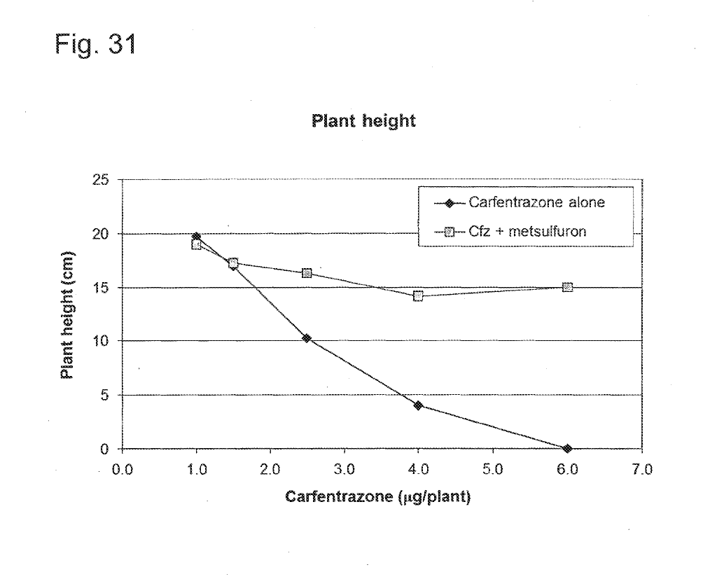

### DETAILED DESCRIPTION OF THE INVENTION

### Technical Problem

Weed control in irrigated turf, soybeans, cereals, sugarcane and paddy crops is characterised by difficulties in conventional spray application of herbicides, losses to dilution, leaching and run-off.

The goal was, therefore, to devise a means that provides for the placement of a herbicide and, in particular, a non-selective herbicide, such that there was adequate weed control, and no or little injury to crops such as rice or turf grass.

### Solution to Problem

To improve the delivery of non-selective herbicides to rice and turf and sensitive crops, we have constructed a simple granule system in which the solubility and rate of transfer of the herbicide from the granule to the outside environment is regulated.

There are two levels of formulation:

Sub-particles

Granules

The sub-particle consists of one or more matrix materials and an active ingredient. They are characterized by being generally small, less than 1 mm in diameter, and for purposes of direct spraying less than 50 μm in diameter. The matrix generally has some affinity for the active ingredient and does not release the active ingredient immediately into water and typically less than 30% of the active ingredient would be released into water within 2 h after mixing the sub-particles with water.

The granule consists of a granule forming matrix, an adhesive or binding agent, dispersants, surfactants, and one or more herbicides that are either in the matrix or bound in dispersable sub-particless that are distributed in the granule matrix. The adhesive fulfills a dual purpose of binding the granule, and modulating the distribution of the granule contents to water.

The sub-particles have properties that are specific to the pesticide to be distributed. By including the pesticide to be distributed into a sub-particle, its properties of distribution can be tuned separately from those of other ingredients in the granule. For example, for compounds that are very hydrophobic, an excessively hydrophobic sub-particle matrix may lead to no release at al. Thus, mechanisms of release can be tuned to each active ingredient by first incorporating them in a sub-particle, and then mixing this in a large granule for distribution, either by hand or in a spray. In instances where one component has no need of modulated release, it may be easily incorporated in the easily dispersed granule matrix, separate from the sub-particle.

Important in the invention is also the fact that more than 95% of the active ingredient becomes biologically available in a reasonable time after application. To facilitate this release, the compartment containing the active ingredient should be amenable to a staged degradation, even in soil or water and in the absence of light. Means to promote degradation include using inherently unstable polymers, and mixing into the overall granule composition either inherently water soluble components (e.g. PEG, urea, ammonium sulfate), or components that are highly attractive to bacteria and funghi that normally inhabit places where the sub-particle is located. Thus, adding small quantities of amines, or trace-element phosphate salts or similar nutrients can lead to biological attack on the sub-particle enhancing its break-down and substance release.

Thus the invention includes the concept of having two or more separate compartments to modulate the overall release of the compounds, said compartments being so constructed and composed as to provide the appropriate exposure kinetics in use.

### Advantageous Effects of Invention

The sub-particle provides a means of distributing an active ingredient with slow release properties whether by spray or by granule. Rapidly dispersing granules with high active ingredient loading can be also used for spray applications.

Spraying sub-particles is also a means to prevent a non-selective herbicide injuring a crop via leaf uptake. Sub-particles retain the herbicide and are washed from the leaves to the soil where they contact weeds. This is important for crops such as wheat, soybean or sugarcane where a herbicide may be used post-emergent.

The granule is a convenient application form for producers with small allotments such as paddy rice farmers, or for growers of turf where spays are complicated by the needs of near neighbours sensitive to drift or odour or for broad acre farmers who wish to apply fertilisers and herbicides together and who do not have convenient access to water.

The granule allows the use of less selective herbicides or herbicide combinations, and thus offers a means to control weeds that are not otherwise easily controlled. In particular, Cyperus species may be controlled by the granules.

The granules may be used in flooded paddies, recently irrigated turf, or in areas where it is inconvenient or impossible to remove irrigation water. The granules allow small holders the means to apply crop protection chemicals without expensive equipment, and without risk of exposing airways or eyes to aerosols or spray materials. Granules can be easily measured and distributed by hand. Using granules that are designed for uniform dispersal is advantageous because this compensates for uneven application. Using granules that form stable foams is useful because these foams are visible and are an indicator of the uniformity of the distribution obtained. Addition of dyes can also allow the foams to be more easily localized.

The invention now will be described more fully hereinafter through reference to various embodiments. These embodiments are provided so that this disclosure will be thorough and complete, and will fully convey the scope of the invention to those skilled in the art. Indeed, the invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

The invention consists of the following elements:

A method of controlling pests in crops and turf comprising the application of a granule containing two or more chemically distinct compartments and one or more pesticide active ingredients, such that the rate of release of at least one ingredient is retarded such that between 10, and 30% is released within 24 hours and the remainder over a period of a further 19 days. In another embodiment, the remainder is released within 10 days. In another embodiment, the remainder is released within 40 days.

A granule or suspension formulation of one or more pesticide active ingredients in which the release of at least one of the pesticides is modulated either by mixing and applying two different granule types, or by formulating a granule with two or more distinct compartments such as a sub-particle and the granule matrix, the release being such that the rate of release of at least one ingredient is retarded such that between 10, and 30% is released within 24 hours and the remainder over a period of a further 19 days. In another embodiment, the remainder is released within 10 days or 40 days

In a preferred embodiment, one or more of the active ingredients is a herbicide. In a more preferred embodiment, at least one of the components is the herbicide sulfentrazone. In a still more preferred embodiment, sulfentrazone is so formulated as to restrict or modulate its release to the water or soil environment. In another embodiment, sulfentrazone is formulated in a sub-particle.

A method of controlling weeds in rice comprising contacting the rice paddy or field with a mixture of herbicides containing sulfentrazone. In a preferred embodiment, the mixture also contains clomazone. In another preferred embodiment, the mixture contains an ALS inhibitor class herbicide. In another preferred embodiment, the method comprises using less than 300 g per hectare of sulfentrazone in a single application, in a still more preferred embodiment, the use rate is less than 200 g, in a still more preferred embodiment, it is less than 125, 100, 80, 75, 70, 65, 60, 55, 50, 45, 40, 35, or 30 g/ha in any single application.

The method provides for the application of granules at various times after seeding or transplanting rice. In a preferred embodiment, application is within 1 day and up to 14 days after seeding or within 1 day and up to 8 days after transplanting.

The method provides for the application of granules by various means including mixing with and spreading with fertiliser, spraying with a coarse nozzle in low volumes of water, or hand broadcasting.

A method of controlling weeds in field crops comprising contacting the field with a mixture of herbicides containing sulfentrazone. In one embodiment, the mixture also contains clomazone. In another preferred embodiment, the mixture contains an ALS inhibitor class herbicide. In one embodiment, the ALS inhibitor is halosulfuron. In another preferred embodiment, the method comprises using less than 300 g per hectare of sulfentrazone in a single application, in a still more preferred embodiment, the use rate is less than 200 g, in a still more preferred embodiment, it is less than 125, 100, 80, 75, 70, 65, 60, 55, 50, 45, 40, 35, or 30 g/ha in any single application.

Granules for mixing with fertilizer are either large granules of more than 1 mm diameter, or particles less than 1 mm that adhere to fertilizer granules. Particles for suspension and coarse spraying are less than 250 μm in diameter and are suspended with assistance of surfactants. In a preferred embodiment, particles for suspension and fine spraying are less than 30 μm in diameter and are suspended with assistance of surfactants. Granules for broadcast application are greater than 250 μm and up to 25 mm in diameter.

The granules have two main compartments. There is an outer compartment comprising a granule forming matrix, and one or more additional compartments comprising the sub-components. The herbicide in the granule forming matrix is initially available, and the herbicide in the sub-components becomes available later after dispersal of the sub-components.

The granule forming matrix is termed a carrier and comprises soluble or dispersable materials selected from the group consisting of organic carriers, inorganic carriers, and combinations thereof. In one embodiment, the organic carrier is selected from paper, cellulose, glucose, sucrose, corn starch, paper, and wood chip, and the inorganic carrier is selected from kaolin, bentonite, vermiculite, soil particles, white carbon, zeolite, diatomaceous earth, coral sand, fertilizer components, Borresperse NA (Borregaard), fine sand, coarse sand, clay, calcium oxide, magnesium chloride, talc, pumice, tuff, silica gel, alumina, magnesia, lime stone, chalk, calcite, montmorillonite, ceramic, perlite, Sipernat 50S, Supragil WP (Rodia), Polyvinylpyrrolidone, coral sand, and combinations of thereof wherein the total concentration of carriers in the composition is about 10% to about 99%.

The sub-particles comprise polymer binders that are not easily water soluble, salts, fertilisers, surfactants, herbicide active ingredient and pH modifiers. The sub-components are designed to modify herbicide availability over a pre-determined time. The time is defined by a test system described in example 1. The key parameters are the amount of herbicide released after 1, 24, 72, 96, 120 and more hours in contact with water up to 10 or 20 days. In one embodiment, the time for a sub-particle to the release into solution >90% of the applied sub-component herbicide is >1, 2, 3, 5, 7, 10 or 20 days.

The release of herbicide from the sub-particles is controlled by various factors including the concentration of herbicide, polymers and salts relative to each other. Increasing the concentration of water insoluble polymer slows the rate of release. Increasing the concentration of water soluble salts in the insoluble polymer matrix increases release rate of the herbicide. Using salts that form modify the pH around the granule, sub-particle, can, depending on the pKa of the herbicide, modify the solubility, and thus the release kinetics.

Thus, in a preferred embodiment, the polymers in the sub-particles are selected from the group consisting of natural polymers, derivatives of natural polymers, and synthetic polymers, wherein the natural polymer binders are selected from the group consisting of lipids, starch, gelatin, proteins, chitin, celluloses, lignin, resins, and combinations thereof, and wherein the synthetic polymer is selected from the group consisting of polystyrene, latex, polyvinylene, polystyrene, polyvinyl alcohol, poly(methyl methacrylate), polyvinyl acetate, polyvinylchloride, polycaprolactone, polylactide, polyethylene glycol, polypropylene glycol, polyacrylates, polyethylene imines, polyvinyl amines, and polyhydroxybutyrate.

In a preferred embodiment, the lipid is selected from the group consisting of fatty acids with at least 6 carbon atoms, paraffin waxes, stearic acid, octadecylamine. In another embodiment, the resin is selected from the group consisting of dammar, olibanum, myrrh, galipot, and rosin.. In another embodiment, the derivatives of natural polymers are selected from the group consisting of alkylated derivatives, salts, esterified derivatives, hydroxyl derivatives, nitro derivatives, and combinations thereof. In another embodiment, the natural polymer is cellulose, and the derivative of cellulose is selected from the group consisting of cellulose acetate butyrate, hydroxypropyl methyl cellulose, hydroxypropyl cellulose, methyl cellulose, ethyl cellulose, chitosan, cellulose acetate, and nitrocellulose. In another embodiment, the polymer is an alkyl amine, for example, polyethyleneimine.

In certain instances the action of the sub-particle is improved with longer polymer components. In a preferred embodiment, the total concentration of the polymers in the sub-particles is about 5% to about 95% of the final composition on a dry weight basis, and 0.1 to 10% of the granule weight. In another preferred embodiment, the polymers have an average molecular weight of >about 2,500, 5000, or 10,000 Da.

The release profiles of the granules may be improved by adding appropriate surfactants, notably those that are solid or liquid at 25 C. These surface active agents are selected from the group consisting of non-ionic surfactants, anionic surfactants, cationic surfactants, lipid-based surfactants, branched surfactants, straight surfactants, silicon-based surfactants, and combinations thereof.

In one embodiment, the non-ionic surfactant is selected from the group consisting of alkylpolyoxyethylenes, tweens, spans, sulfoalkylamides, ethoxylated acetylenic diols, polyethylene oxides, polypropylene oxides, polyoxyalkylene alkyl ethers, polyoxyalkylene alkyl phenyl ethers, polyoxyalkylene alkyl aryl ethers, polyoxyethylene polyoxypropylene alkyl aryl ethers, alkoxylates, castor oil alkoxylates, polyoxyethylene carboxylic acid esters, polyoxyethylene polyoxypropylene block copolymers, and Brij types like Polyoxyethylene-20 hexadecyl ether.

In another embodiment, the anionic surfactant is selected from the group consisting of sodium dodecyl sulfate, dialkyl sulfocarboxylic acid esters, alkyl or dialkylnaphthalenesulfonic acids alkyl sulfates, alkyl phosphates carboxylates, α-olefinesulfonates, dialkyl sulfosuccinates, alkyl ether sulfuric acid esters, alkyl phenyl ether sulfuric acid esters, aryl phenyl ether sulfuric acid esters, alkyl ether phosphoric acid esters, alkyl phenyl ether phosphoric acid esters, aryl phenyl ether phosphoric acid esters, polyoxyalkylene alkyl ether sulfuric acid esters, polyoxyalkylene alkyl phenyl ether sulfuric acid esters, polyoxyalkylene aryl phenyl ether sulfuric acid esters, polyoxyalkylene alkyl ether phosphoric acid esters, polyoxyalkylene alkyl phenyl ether phosphoric acid esters, and polyoxyalkylene aryl phenyl ether phosphoric acid esters.

In another embodiment, the aryl phenyl ether sulfuric acid ester is selected from the group consisting of styryl phenyl ether sulfate, distyryl phenyl ether sulfate, and tristyryl phenyl ether sulfate.

In another embodiment, the aryl phenyl ether phosphoric acid ester is selected from the group consisting of styryl phenyl ether phosphate, distyryl phenyl ether phosphate, and tristyryl phenyl ether phosphates.

In another embodiment, the polyoxyalkylene alkyl ether sulfuric acid ester is polyoxyethylene alkyl ether sulfate.

In another embodiment, the polyoxyalkylene alkyl phenyl ether sulfuric acid ester is polyoxyethylene nonyl phenyl ether sulfate.

In another embodiment, the polyoxyalkylene aryl phenyl ether sulfuric acid ester is selected from the group consisting of polyoxyethylene styryl phenyl ether sulfate, polyoxyethylene distyryl phenyl ether sulfate, and polyoxyethylene tristyryl phenyl ether sulfate.

In another embodiment, the polyoxyalkylene alkyl ether phosphoric acid ester is polyoxyethylene nonyl ether phosphate.

In another embodiment, the polyoxyalkylene alkyl phenyl ether phosphoric acid ester is polyoxyethylene nonyl phenyl ether phosphate.

In another embodiment, the polyoxyalkylene aryl phenyl ether phosphoric acid ester is selected from the group consisting of polyoxyethylene styryl phenyl ether phosphates, polyoxyethylene distyryl phenyl ether phosphates, and polyoxyethylene tristyryl phenyl ether phosphates.

In another embodiment, the cationic surfactant is selected from the group consisting of odecyl trimethyl ammonium chloride, DTAC, and polyoxyethylene alkylamines.

In another embodiment, the lipid-based surfactant is selected from the group consisting of polyoxyethylenefatty acid esters, polyvalent alcohol fatty acid esters, polyoxyethylene polyvalent alcohol fatty acid esters, and sorbitanfatty acid esters.

In another embodiment, wherein the branched surfactant is selected from the group consisting of poly(ethylene glycol)-block-poly(propylene glycol)-block-poly(ethylene glycol), polyoxyethylene (5) isooctylphenyl ether Polyoxyethylene (5) octylphenyl ether, branched, polyoxyethylene (5) nonylphenylether, polyethylene-block-poly(ethylene glycol), polyethylene-block-poly(ethylene glycol), polyoxyethylene (9) nonylphenylether, polyoxyethylene (12) nonylphenyl ether, branched polyoxyethylene (12) octylphenyl ether, branched polyoxyethylene (40) nonylphenyl ether, branched dinonylphenyl and nonylphenyl ethers, and branched polyoxyethylene (2) isooctylphenyl ether polyoxyethylene (2) octylphenyl ether.

In another embodiment, the straight surfactant is selected from the group consisting of polyethylene glycol sorbitan mono stearate, polyoxyethylene sorbitan monostearate, polyoxyethylene (12) isooctylphenyl ether, polyoxyethylenesorbitan monopalmitate, polyethylene glycol sorbitan monolaurate, polyoxyethylenesorbitan monolaurate, dinonylphenyl ether polyoxyethylene, sorbitan monopalmitate, Triton™ SP-type straight surfactants, and PEG-PPG-PEG Pluronic® type straight surfactants.

In another embodiment, the straight silicon-based surfactant is a silwet type surfactant. In another embodiment, the surfactant is Metaupon OMT, Tween40, Witconate™ 60T, (TEA-Dodecylbenzene Sulfonate), Witcolate™ 1050, (Sodium C12-15 Pareth Sulfate), Lankropol KO2 is a sodium di-octyl sulphosuccinate, and alkalonamides such as cocomonoethanolamide. cocodiethanolamide (Superamide), cocodiethanolamide, cocomonoethanolamide. lauric monoethanolamide. cocoamidopropyl betaine. cocoamidopropyl betaine. cocobetaine. laurylamidopropyl betaine, sodium lauryl ether sulphate, sodium Lauryl sulphate, triethanol amine Lauryl sulphate) Leunapon F 1618/25

In one embodiment, the total concentration of surface active agents in the composition is about 0.01% to about 20%.

In another embodiment, the sub-particles contain polymers comprising one or more cross-linkers selected from the group consisting of UV-activated cross-linkers, heat-activated cross-linkers, catalyst-activated cross-linkers, volatile cross-linkers, and combinations thereof. In a preferred embodiment, the cross-linkers contain functional groups selected from aldehydes, isocyanates, epoxides, and acid chlorides. In a still more preferred embodiment,the cross-linkers are 3-chloro-1,2-propylene oxide, methyl benzenesulfonate, 4-toluenesulfonyl chloride, prop-2-enoic acid, butyl glycidyl ether, phenyl glycidyl ether, cresyl glycidyl ether, and polyvinyl ethylene glycol diglycidyl ether with a total concentration of cross-linkers in the composition between 0.001% to about 1% on a dry weight basis.

In a preferred embodiment, the sub-particles comprise one or more other ingredients selected from the group consisting of fertilizers, nutrients, salts, micronutrients, macronutrients, inorganic nutrients, organic materials, materials comprising N, P, K, S, Fe, Cu, Mb, Ca, Mg, B, Mn, Zn, Ni, Mo or Co, and combinations thereof with a concentration between about 0% to about 90%.

In a preferred embodiment, the granule matrix and the sub-particle contain one or more pesticides selected from the group consisting of herbicides, insecticides, bactericides, rodenticides, nematicides, and fungicides.

In a preferred embodiment, the pesticide is a herbicide selected from the group consisting of 2,4-D, acetochlor, acifluorfen-sodium, alachlor, allidochlor, ametryn, amicarbazone, anilofos, atraton, azimsulfuron, atrazine, benfluralin, benfuresate, bensulfuron-methyl, bentazone, benzipram, benzobicyclon, bifenox, bispyribac-sodium, bromobutide, butachlor, butam, buturon, cafenstrole, carbetamide, carfentrazone-ethyl, chlomethoxyfen, chlorimuron-ethyl, chlornidine, chlorpropham, cinosulfuron, clethodim, clomazone, clodinafop-propargyl, cloransulam-methyl, clopyralid, cumyluron, cyclosulfamuron, cyhalofop-butyl, dibutalin, diclosulam, dimethenamid, dimethametryn, dinitramine, diphenamid, dipropalin, diuron, ethalfluralin, ethoxysulfuron, etobenzanid, fenoxaprop-P-ethyl, fenoxasulfone, fenuron, fentrazamide, flazasulfuron, florasulam, fluazifop-P-butyl, flucetosulfuron, fluchloralin, flufenacet, flumetsulam, flumioxazin, fluoronitrofen, fluroxypyr, fomesafen, glufosinate-ammonium, hexazinone, imazapyr, imazaquin, imazethapyr, imazosulfuron, imidazolinones, indanofan, isoproturon, isoxaben, isoxaflutole, lactofen, linuron, MCPA, mefenacet, mefluidide, metamifop, metazachlor, metazosulfuron, S-metolachlor, metribuzin, metsulfuron, molinate, monalide, naproanilide, napropamide, naptalam, nitralin, orbencarb, orthosulfamuron, oryzalin, oxadiargyl, oxadiazon, oxaziclomefone, oxyfluorfen, pendimethalin, penoxsulam, pentoxazone, phenobenzuron, picloram, piperophos, prazosulfuron, pretilachlor, prodiamine, profoxydim, prometryn, propanil, propaquizafop, propham, propisochlor, propyrisulfuron, propyzamide, pyraclonil, pyraflufen-ethyl, pyraclostrobin, pyrazolate, pyrazosulfuron-ethyl, pyriftalid, pyriminobac-methyl, pyrimisulfan, pyrithiobac-sodium, pyroxsulam, quinclorac, quizalofop-P-ethyl, quizalofop-P-tefuryl, sethoxydim, sulfentrazone, sulfometuron-methyl, sulfosate, tefuryltrione, thifensulfuron-methyl, thiobencarb, triallate, tribenuron-methyl, triclopyr, trifluralin

In another embodiment, the pesticide is a fungicide selected from the group consisting of azoxystrobin, benomyl, benthiavalicarb-isopropyl, buconazole, captan, carbendazim, carboxin, chlorothalonil, cyflufenamid, cymoxanil, cyproconazole, cyprodinil, difenoconazole, dimetachlone, diniconazole, drazoxolon, edifenphos, enestroburin, epoxiconazole, ethylicin, etofenprox, etridiazole, fenapanil, fenbuconazole, fludioxonil, fluoxastrobin, flusulfamide, flutolanil, flutriafol, fosetyl-aluminum, hexaconazole, hymexazol, imazalil, iminoctadine triacetate, iminoctadine tris albesilate, iprobenfos, iprodione, isoprothiolane, jinggangmycin, kasugamycin, mancozeb, mefenoxam, mepanipyrim, mepronil, metalaxyl, myclobutanil, myclozolin, orysastrobin, pefurazoate, pencycuron, picoxystrobin, prochloraz, procymidone, propamocarb, propiconazole, pyracarbolid, pyraclostrobin, quinoxyfen, simeconazole, streptomycin, streptomycin sesquisulfate, tebuconazole, tetraconazole, thiophanate-methyl, tiadinil, thiram, tolclofos-methyl, triadimefon, triadimenol, tricyclazole, trifloxystrobin, triflumizole, validamycin,

In another embodiment, the pesticide is an insecticide is selected from the group consisting of abamectin, acephate, acetamiprid, aldicarb, alpha-cypermethrin, azinphos-methyl, azinphos-ethyl, bacillus thuringiensis, beta-cypermethrin, beta-cyfluthrin, bifenthrin, bromophos, buprofezin, carbofuran, carbosulfan, cartap, chlorantraniliprole, chlorbenzuron, chlorfenapyr, chlorfluazuron, chlorpyrifos, chlorpyrifos-methyl, clofentezine, Clothianidin, cyfluthrin, cyhalothrin, cypermethrin, theta-cypermethrin, zeta-cypermethrin, cyromazine, deltamethrin, dialifos, diazinon, dichlorvos, diflubenzuron, dimethoate, dinotefuran, endosulfan, esfenvalerate, ethiprole, etofenprox, fenamiphos, fenitrothion, fenpropathrin, fenvalerate, fipronil, flubendiamide, flucythrinate, gamma-cyhalothrin, hexaflumuron, imidacloprid, indoxacarb, isocarbophos, isofenphos-methyl, isoprocarb, lambda-cyhalothrin, liuyangmycin, malathion, permethrin, methamidophos, methidathion, methiocarb, methomyl, mevinphos, monocrotophos, monosultap, novaluron, omethoate, parathion, parathion-methyl, phorate, phosalone, phosmet, phosphamidon, phoxim, pirimicarb, profenofos, pyridaben, quinalphos, spinetoram, spinosad, sulfoxaflor, tebufenozide, teflubenzuron, thiamethoxam, thiodicarb, tolfenpyrad, tralomethrin, triazophos, trichlorfon

In another embodiment, the pesticide is a bactericide is selected from the group consisting of Amicarthiazol, bismerthiazol, bronopol, cellocidin, chloramphenicol, copper hydroxide, cresol, dichlorophen, dipyrithione, dodicin, ethylicin, fenaminosulf, formaldehyde, hexachlorophene, hydrargaphen, 8-hydroxyquinoline sulfate, kasugamycin, nitrapyrin, octhilinone, oxolinic acid, oxytetracycline, phenazine oxide, probenazole, saijunmao, saisentong, streptomycin, tecloftalam, thiodiazole-copper, thiomersal, xinjunan, zinc thiazole,

In another embodiment, the pesticide is a nematicide is selected from the group consisting of abamectin, carvacrol, benomyl, carbofuran, carbosulfan, cloethocarb alanycarb, aldicarb, aldoxycarb, oxamyl, tirpate, diamidafos, fenamiphos, fosthietan, phosphamidon, cadusafos, chlorpyrifos, dichlofenthion, dimethoate, ethoprophos, fensulfothion, fosthiazate, heterophos, isamidofos, isazofos, phorate, phosphocarb, terbufos, thionazin, triazophosimicyafos, acetoprole, benclothiaz, chloropicrin, dazomet, DBCP, DCIP, fluensulfone, furfural, metam, methyl isothiocyanate and xylenols.

In a preferred embodiment, the concentration of at least one pesticide in the composition is about 0.01% to about 75%

In a more preferred embodiment, the concentration of at least one pesticide in the composition is about 0.01% to about 50%

In another aspect, the invention comprises a means of preparing granules and sub-particles of this type comprising the following steps:

a) dissolving the one or more pesticides and the one or more polymer compositions in a solvent to provide a first mixture with or without the addition of salts, or other water soluble materials; and b) using one or more carriers to absorb the first mixture and mix the carriers and the first mixture to provide the composition according to claim 1.

In another embodiment, the method comprises drying the mixture obtained from step b).

In another embodiment, the method comprises the following steps:

a) dissolving the one or more pesticides and the one or more polymer compositions in a solvent with or without the addition of salts, or other water soluble materials—Solution 1;

b) using one or more carriers to absorb solution 1 to provide Mix 2;

c) removing the solvent from Mix 2 to provide a sub-particle;

d) mixing the sub-particle with one or more pesticides, one or more surface active agents, and other formulation inerts if desired to provide Mix 3;

e) breaking Mix 3 down to small particles to provide a Mix 4;

f) adding water into Mix 4 and mixing to provide the Granulation mix; and

g) pressing the Granulation mix into granules, tablets, or disks.

In a preferred embodiment, step (e) uses a Hammer mill and/or an air jet mill to break Mix 3.

b. An alternative to step g, further comprising drying the granules, tablet, or disks.

18. A method for preparing the sub-particles or granules, comprising the following steps:

a) dissolving one or more pesticides and the one or more polymer compositions in a solvent, usually an organic solvent with or without the addition of salts or other water soluble compounds (e.g. ZnCl, urea, CaSO4, methylcellulose), to provide a Mix 1;

b) spreading the Mix 1 onto a flat surface to form a film, or drying it in a spray using a spray drying or congealing system, or grinding in a vacume;

c) breaking the resulting film or product down to small particles;

d) mixing the small particles with one or more pesticides, one or more surface active agents, and other formulation inerts to provide Mix 2;

e) adding water, or a binder mixture,into the Mix 2 and mixing to provide the granulation mix; and

f) pressing the granulation mix into granules, tablets, or disks.

a. The method of step b above, further comprising drying the film formed in step (b).

b. The method of step b above, wherein the flat surface is a smooth surface.

i. The method of step b above, wherein the flat smooth surface is a stainless steel plate.

c. The method of step c above, wherein the film is broken down by a mechanical device like a grinding mill, or cutting mill.

d. The method of step c above, further comprising drying the granules, tablet, or disks.

19. Solvents: The method above, wherein the solvent is selected from the group consisting of polar solvents, nonpolar solvents, and combinations thereof.

a. The method for forming sub-particles or granules, wherein the polar solvent is selected from the group consisting of dichloromethane, chloroform, acetone, methanol, ethanol, acetonitrile, NMP, DMF, methyl oleate, decanamide, acetophenone, NMP, cyclohexane/dichloromethane/methanol (90/8.5/1.5 [[YW: v/v/v/?]], ethylacetate, dichloromethane/methanol (75/25), C1 to C4 esters and mixes thereof, and tetrahydrofuran.

b. The method wherein the nonpolar solvent is selected from the group consisting of toluene, xylene, aromatic100, aromatic 150, aromatic 200, paraffin oil, supercritical CO2, lower and cyclic alkanes (C4-C10), di-isopropyl ether, tert-butyl-ether, and petroleum fractions.

c. The method for forming sub-particles or granules, wherein the solubility of at least one polymer in the solvent is about 20% (w/v) or higher.

d. The method for forming sub-particles or granules, wherein the solubility of at least one pesticide in the solvent is about 2% (w/v) or higher.

The preparation of sub-particles may be achieved by means of melting or a combination of melting and solvent dissolutions. In one embodiment, the pesticide (e.g. sulfentrazone) is mixed with a solvent (e.g. dichloromethane) and a polymer (e.g. acetylbuteryl cellulose) and dried. The dried material is then ground and when required is heated to a melt, the melt is then extruded, or sprayed to form particles on cooling.

Alternatively, the materials may be mixed directly without the use of a solvent step and melted together directly by heating to an appropriate temperature (e.g. up to 180 C) where the materials are molten but do not decompose. The resulting molten material can be then spray congealed, extruded into a fibre, blown into a film, or spread on a cooled surface and size reduced by scraping and grinding. Fines resulting from grinding that are too small to be used in a formulation are re-melted with subsequent batches.

The sub-particles from the molten process may also be produced containing mineral salts or additional polymers. In one embodiment, fine ground (e.g. 20 μm or less) mineral salts are mixed into the melt at the last stage prior to extrusion, thus forming water soluble inclusions that increase the rate of release.

Important to the performance of the sub-components is the release of the majority of the applied herbicide within 21 days of application. This can be achieved in a number of ways:

Incorporation of a water soluble polymer in the insoluble polymer matrix.

Including small particles of alkaline salts in the sub-components that are only slowly exposed to water.

Including a limited gas generation capacity in the sub-components to disrupt it as it wets

Inclusion of nitrogen, phosphorous, potassium or micronutrient sources to promote bacterial activity.

Use of biodegradable gel forming components to slow diffusion from the sub-components.

The use of a surfactant in the sub-particles can assist to increase their transport in water and their dispersal by convection.

The granules and sub-particles can assist in dispersal of the herbicide in various ways and under various conditions. These are now described for each condition.

Dryland application. The granules for this purpose are spread by conventional spreading machines, either mixed with fertilizer, or sand or spread undiluted. Granules are designed to distribute with the first rainfall and to disintegrate on the soil surface. Granules are easily dispersed once moisture is present.

In a preferred embodiment, the granules form a stable foam due to the inclusion of surfactants and foam stabilisers and gas generating salts such as bicarbonate and acids. The foam carries the sub-components and rain drops cause the foam to break and to be diluted and distributed from the point of origin. Once the foam is distributed, the sub-components have access to water and begin to release herbicide. Contact between the sub-components and soil causes them to be a source of macro and micro-nutrients attracting roots, microbes and further enhancing release of herbicide.

Application to water. Granules are broadcast over a field in which surface water is present, e.g. a rice paddy or flooded turf. Granules may be simply dispersed, or they may be actively dispersed. Methods of active dispersal include use of gas generation in either the outer granule, or the sub-components, the use of differential surfactant release in different parts of the granule, the use of sub-components of varying density, the use of foams of varying duration of stability, and the use of gels such as starch, polyacrylate, or mixtures of water soluble polymers like PVP or polyvinylacetate and surfactants.

When using gas generation, the addition of surfactants causes the production of foam. Foam can be enhanced by the addition of foam boosting substances which include: Witconate™ 60T, (TEA-Dodecylbenzene Sulfonate), Witcolate™ 1050, (Sodium C12-15 Pareth Sulfate), Lankropol KO2 is a sodium di-octyl sulphosuccinate, and alkalonamides such as cocomonoethanolamide. cocodiethanolamide (Superamide), cocodiethanolamide, cocomonoethanolamide. lauric monoethanolamide. cocoamidopropyl bBetaine. cocoamidopropyl betaine. cocobetaine. laurylamidopropyl betaine, sodium lauryl ether sulphate, sodium Lauryl sulphate, triethanol amine Lauryl sulphate) Leunapon F 1618/25

The granules for hand dispersal are formed by addition of outer matrix elements which may be organic or inorganic in origin and which has the property of forming stable particles between 0.5 and 20 mm in diameter, when appropriately formulated or prepared. The granule matrix is inherently porous, or may be easily rendered porous, or has a low bulk density.

The sub-particles for spray application are preferably less than 50, 40, 30, 20 or 10 μm in diameter. They may be mixed with a hydrophilic formulant and a surfactant to prevent caking. They may be formulated in dispersible granules to ease dispensing. Upon placement in a spray system, the sub-particles become suspended in the spray water. The spray should be used soon after mixing, in a preferred embodiment, within 2 hours, of mixing. In another embodiment the formulation containing the sub-particles is applied to spray medium via a separate metered dispenser meaning that the sub-particles are only in contact with the spray medium for a short time before being sprayed.

2. An adhesive that may be a single material or a mixture of different adhesives, that has the effect of both stabilising the granule, and retaining the herbicidal ingredients. The adhesive is ideally soluble or dispersible in a suitable solvent for solving the herbicidal ingredients.

3. In addition to sulfentrazone, an additional herbicide or herbicides, selected from the classes: ALS inhibitors (halosulfuron, penoxsulam), bleaching herbicides such as clomazone, carfentrazone or oxfluorfen, anilide herbicides such as propanl or prodiamine. The herbicide is present at a concentration from 0.01% to 10% on a dry weight basis.

In certain cases, a final coating with a film forming material such as a stearic acid salt may be used to reduce dust or improve particle handling.

Granules are prepared by mixing the various ingredients in the appropriate proportions, with addition of a solvent or other mixing medium to promote adhesion. The granules are formed via accretion in granulation machinery known in the art, or by mixing with water and extrusion.

In another preferred embodiment, granules are prepared using a pre-formed granule in which a herbicide and an adhesive are absorbed into a granule in solution or fine suspension, with or without vacume infiltration, and the granules then dried.

Granule materials are selected from those with high absorbative capacity and include clays, diatomaceous earth, tuff, pummus and expanded forms of wood or cellulose.

In a preferred embodiment, at least one of the herbicides is a non-selective herbicide:

In another embodiment, a herbicide combination is used

The granule size can be adjusted for various purposes. In one embodiment, the granules are in the size range 0.5 to 3 mm which provides a means of hand or mechanical dispersal that allows even dispersal of a larger number of granules in the target area, albeit with limited reservoirs of compound and limited duration of effect.

In another embodiment, granules are in the size range 2 to 8 mm which provides for greater duration of effect, albeit at the expense of additional weight of granules per hectare.

The granules may be characterised by the rate and degree to which herbicide is released to free water. More specifically, the granules may be classified according to the proportion of the total herbicide contained that is released in a starndard system over 12 h, 24 h and 96 h.

In one embodiment, the granules release greater than 90% of their herbicidal content within 24 h. In another embodiment, between 60 and 90% is released within 24 h and in another emobodiment, less than 60% is released within 24 h.

In another embodiment, the granule contains fertiliser materials, notably those containing micronutrients as part of the granule matrix. In a preferred embodiment, the fertiliser is also in granular form and the herbicide/adhesive mixture is absorbed to preformed granules. In a still preferred embodiment, the fertiliser contains a micronutrient such as iron, manganese, molybdenum or magnesium.

A key advantage of the granules is ease of use. The granules may be used even when large amounts of water remain in the target area. In a preferred method of application, the granules are broadcast by hand or mechanically without removal or drainage of standing water.

Coating of granules after drying is achieved by first spraying the granule with a composition comprising a film forming polymer in an appropriate solvent.

In certain embodiments, it may be desirable to use the sub-particles as coatings on seeds either to protect the seedling from pathogens, insects or event parasitic plants (e.g. Striga) or a combination of those. In this application, a pesticide is prepared in a sub-particle by combining it in a solvent with a polymer, or as a melt, as indicated above. One or more pesticides may be used (e.g. a herbicide and a fungicide or a fungicide and an insecticide) and multiple active ingredients may be used. The pesticide is formed into sub-particles in the range of 1000 μm or less and these are coated onto seeds by mixing with an adhesive material such as methyl cellulose in water, or PVP in water or in bulk seed coating materials. In this instance the seed becomes in effect the granule matrix for the sub-particles. In one preferred embodiment, the seed is inherently resistant to the materials in the sub-particle and, in the case of this being a herbicide, is able to tolerate the herbicide released, which may be active on nearby plants, or parasitic plants. In certain embodiments, the seed is only partially resistant to these effects, however, moderation of the herbicide availability by the sub-particle means that the seed can better tolerate the herbicide treatment. In a preferred embodiment, the herbicide release is delayed such that the seedling is less affected and the duration of the effect of the herbicide on weeds is extended. In a still preferred embodiment, this effect is associated with yield enhancement in the presence of parasitic weeds when compared with the same rate or dose of the unformulated technical herbicide. In a preferred embodiment, the herbicide is an ALS inhibitor.

Definitions

non-dispersible means that the composition does no disintegrate or disperse in water within 1 hour of contact.

A “non-selective” herbicide is one which is ordinarily considered to have a low margin of selectivity between desirable species and weeds such that crop damage is observed at rates which control target weeds.

A “selective” herbicide is one which is ordinarily considered to have a margin of selectivity between desirable species and weeds such that there is a rate of application by non-directed spray where the majority of weeds are killed and the majority of the crop plants are un-harmed.

The term “compound” as used herein means a chemical entity, whether in a crude mixture or purified and isolated. “Capsule” shall mean both a polymer based shell used to enclose a drug substance as well as any oral dosage form that can be enterically protected.

The compounds disclosed herein may contain chiral centers, which may be either of the (R) or (S) configuration, or may comprise a mixture thereof.

Accordingly, the present invention also includes stereoisomers of the compounds described herein, where applicable, either individually or admixed in any proportions. Stereoisomers may include, but are not limited to, enantiomers, diastereomers, racemic mixtures, and combinations thereof.

The compounds described herein can also be in the form of an ester, amide, salt, or solvate.

Suitable acid addition salts according to the present invention include organic and inorganic acids.

In the case of solid compositions, it is understood that the compounds used in the compositions of the invention may exist in different forms. For example, the compounds may exist in stable and metastable crystalline forms and isotropic and amorphous forms, all of which are intended to be within the scope of the present invention.

### EXAMPLES

The present invention will now be described with specific reference to various examples. The following examples are not intended to be limiting of the invention and are rather provided as exemplary embodiments.

### Example 1. General Extraction Procedures

Mixed System: The test sample is immersed in 25 or 40ml of deionized water and kept standing still. Before sampling, the setup is gently shaken to ensure homogenous distribution of the extracted material. Samples are taken, centrifuged at 8000 g, and the analytes are quantitated by HPLC-MS.

Standing paddy system. Sample is added to 4 L of water in a 35 cm×30 cm container. The water contains ca. 40 g of soil with 50% organic content spread over the floor of the container. Sample is not disturbed after application. 5 cm from the centre of the container is a cluster of 4 rice seedlings. Water samples are taken from various positions in the container at various times after application, typically, 1, 3, 6, 24, 48, 72, 96, 120 and 144 h after application. Sampling points in the first 24 h are 2 cm from the container corners, at the surface and 2 cm from the floor, and at 4 points at a 10 cm radius from the point of application. In intervals of 24 h or more, diffusion and convection usually compensate for any sampling position errors.

### Example 2. Formulation of Sulfentrazone in PMMA on Biodac

3 mg of Sulfentrazone and 15 mg of poly(methyl methacrylate) as a binder are dissolved in 0.2 ml of Dichloromethane, and mixed with 1.5 g of Biodac granules (12/20 mesh). The mixture is shaken for 3 h to ensure even distribution, and then air dried for 12 h.

The Procedure is performed in the same way without the polymer to prepare a without binder sample for comparison. 125 mg of each preparation are extracted with 11 of water with permanent slow stirring.

### Example 3. Formulation of Sulfentrazone in Collodium on Vermiculite

2.5mg of collodium (as 32 μl of a 7.8% solution in ethanol/diethylether) as a binder and 0.25 mg sulfentrazone (as 25 μl of a 1% solution in acetone) are mixed and applied to 125 mg of vermiculite. The mixture is shaken for 3 h to ensure even distributin and air dried for 12 h.

The Procedure is performed in the same way without the binder to prepare a without binder sample for comparison. The samples are tested for release rate using the mixed system of example 1.

4. Synthesis of solid sulfentrazone melt formulation; 58.3 g of Noram(r) 42 (Ceca) are melted and 48 g of fine powdered Sulfentrazone are dissolved with stirring. When a clear melt is formed, the mixture is poured on a plate and left cool. Concentration of Sulfentrazone: 41.7%

5. Formulation of Sulfentrazone in paraffin oil on Biodac (058)

The compound from example 4 is dissolved in Paraffin oil at 60°, until a homogenous, clear to slightly opalescent solution is formed. The mixture is augmented with Biodac 20/50 granules and gently mixed for 20 h.

| | entry | | |
|---|---|---|---|
| | 5a | 5b | 5c |
| S5 [mg] | 40.1 | 46.2 | 51.8 |
| Paraffin oil [mg] | 361 | 186 | 124 |
| Biodac [mg] | 3610 | 2090 | 1570 |
| Sulfentrazone [%] | 0.4 | 0.8 | 1.2 |
| Paraffin oil [%] | 9.0 | 8.0 | 7.1 |

Release Kinetics:

9.5 mg of formulation 5b are suspended in 25 ml of deionized water. The setup is shaken to ensure wetting of the particles and left standing. Before sampling, the setup is gently shaken to homogenize the concentration. Samples are taken after 7, 30, 90, and 375 min.

6. Formulation of Sulfentrazone in Polystyrene on Calcium carbonate (066)

Polystyrene is dissolved in Toluene to prepare a 12.5% w/v solution. The solution is augmented with S5 (see table for amounts), then with fine powdered CaCO3 and NaHCO3. The resulting slurry is poured on a glass plate and left to dry for 3 h, then for at least 18 h in an oven at 60° C. The resulting solid is broken in a mortar and sieved to sizes of 150-500 μm, 80-150 μm, and <80 μm.

| | entry | | | |
|---|---|---|---|---|
| | a | b | c | d |
| S5 [mg] | 175.4 | 109 | 68.7 | 182 |
| Polystyrene solution [ml] | 2.8 | 2.6 | 2.7 | 2.1 |
| CaCO3 | 3469 | 2870 | 1220 | 1950 |
| NaHCO3 | 882 | 708 | 309 | 353 |
| Sulfentrazone [%] | 1.5 | 1.1 | 1.5 | 2.8 |
| Polystyrene [%] | 7.2 | 8.1 | 17.4 | 9.6 |
| CaCO3 [%] | 71.1 | 71.5 | 63.0 | 71.0 |
| NaHCO3 [%] | 18.1 | 17.6 | 16.0 | 12.8 |
| Extracted at 24 h [%] | 97 | 96 | 90 | 94 |

7. Formulation of Sulfentrazone in Silica enforced Methylcellulose on Calcium carbonate (051) 723mg of methyl cellulose and 257 mg of Sulfentrazone in 20 ml of methanol are treated with stirring and ultrasonication, until all sulfentrazone is dissolved. 1 ml of 7M NH3 in MeOH is added. 1.5 ml of tetraethoxysilan are added, then water to make up to 25 ml (ca. 3 ml). The mixuture is vigourously shaken for approx. 15 min, then another 5 ml of water are added and the mixture is shaken for further 15 min.

a) 5000 μl of a) are mixed mechanically with 1.5 g of CaCO3, spread on a plate and left drying at RT for 15 h. The resulting material is broken in a mortar. Sulfentrazone content 0.28%.

b) 6000 μl of a) are mixed mechanically with 630 mg of CaCO3, spread on a plate and left drying at RT for 15 h. The resulting material is broken in a mortar. Sulfentrazone content 0.81%.

The samples were extracted following the general mixed procedure of example 1. Additionally, sample b was extracted with 1% citric acid. All formulations were extracted to >85% by 20 minutes after placement in water.

8. Formulation of Sulfentrazone in PEG modified Acetylcellulose (055b,c,d). Acetylcellulose, PEG 8000, and Sulfentrazone are mixed with methanol (approx. 1.5 ml/g of mixture), and chloroform is added to a final volume of approx 5-6 ml/g of mixture. The suspension is vigorously shaken or stirred, until everything is dissolved. Finely powdered CaCO3 and micronized citric acid are added and thoroughly mixed, until the resulting slurry is homogenous. The slurry is poured on a plate and air dried for 3 h, then oven dried at 60° C. over night. The resulting solid is broken in a mortar and sieved to sizes of 150-500 μm, 80-150 μm, and <80 μm.

| entry | a | b | c |
|---|---|---|---|
| Sulfentrazone [mg] | 443 | 131 | 131 |
| Acetylcellulose [mg] | 920 | 305 | 305 |
| PEG 8000 [mg] | 307 | 77 | 77 |
| CaCO3 [mg] | 3590 | 3540 | 1000 |
| Citric acid [mg] | 0 | 0 | 2500 |
| Sulfentrazone [%] | 7.8 | 3.0 | 3.0 |
| Acetylcellulose [%] | 17.5 | 7.5 | 7.6 |
| PEG 8000 [%] | 5.8 | 1.9 | 1.9 |
| CaCO3 [%] | 68.3 | 87.3 | 24.9 |
| citric acid [%] | 0.0 | 0.0 | 62.3 |

9. Formulation of Sulfentrazone and Clomazone in PEG-Modified Acetylcellulose (064)

199 mg of Acetylcellulose, 51 mg of PEG 8000, 58 mg of Sulfentrazone, and 61 mg of Clomazone are suspended in 1.25 ml of methanol. Dichloromethane is added to give 2.5 ml, and the mixture is shaken until complete dissolution. 5.48 g of CaCO3 are added and mixed for 2 h.

a) a portion of above mixture is extruded through a 2.5 mm opening

b) the rest of above mixture is poured on a plate and spread to a film.

Both formulations are air dried overnight and broken to pieces in a mortar.

10. Formulation of Sulfentrazone in PEG modified Polymers on various Carriers (065). A stock solutions are prepared with the following concentrations in methanol/dichloromethane 1+4:

| | | |
|---|---|---|
| I) | PEG 8000 | 10% |
| | Sulfentrazone | 10% |
| II) | Polymer | 12.5% |

for each entry, 200 of stock I) and 480 μl of stock II) are mixed and combined with 1 ml of dichloromethane and 2.00 g of carrier, resulting in formulations with 1% of sulfentrazone, 1% of PEG 8000, 2.8% of polymer, and 95% of carrier.

| | | carrier | | | | |
|---|---|---|---|---|---|---|
| | | | | | powdered | |
| | | CaCO3 | Starch | NaHCO3 | pumice | sucrose |
| Polymer | Acetylcellulose | a | b | c | d | e |
| | Acetyl butyroyl cellulose | f | g | h | i | k |
| | Poly methylmethacrylate | l | m | n | o | p |
| | Poly vinylacetate | g | r | s | t | u |
| % | Acetylcellulose | a: 40 | b: 46 | c: 120 | d: 50 | e: 62 |
| extracted | Acetyl butyroyl cellulose | f: 61 | g: 92 | h: 90 | i: 36 | k: 72 |
| | Poly methylmethacrylate | l: 53 | m: 31 | n: 91 | o: 37 | p: 40 |
| | Poly vinylacetate | q: 80 | r: 70 | s: 64 | t: 88 | u: 31 |

The slurries are air dried for 3 h, then over night oven dried at 60° C. The resulting solid is broken in a mortar and sieved to sizes of 150-500 μm, 80-150 μm, and <80 μm. In the table, the second half indicates the extraction of Sulfentrazone after 90 min using the mixed method of extraction 1 (numbers in % of total).

11. Formulation of Sulfentrazone with PEG modified Acetylcellulose and addition of a Surfactant (068). A stock solution is prepared the following way: 2.37 g of acetylcellulose, 609 mg of PEG 8000, 257 mg of Imwitor (R) 372 C, and 853 mg of Sulfentrazone are suspended in 7 ml of methanol and made up to 20 ml with dichloromethane. The mixture is shaken until everything is dissolved, and aliquots are taken to prepare the different formulations:

| | | a | b | c | d |
|---|---|---|---|---|---|
| ml | Stock solution | 4.5 | 4.95 | 4.3 | 4.9 |
| mg | Acetylcellulose | 533 | 587 | 510 | 581 |
| mg | PEG 8000 | 137 | 151 | 131 | 149 |
| mg | Imwitor 372 C | 58 | 64 | 55 | 63 |
| mg | Sulfentrazone | 192 | 211 | 183 | 209 |
| mg | CaCO3 | 2177 | 680 | 1660 | |
| mg | NaHCO3 | 0 | | 415 | |
| mg | Citric acid | 0 | 2070 | | 2350 |
| % | Acetylcellulose | 17.2 | 15.6 | 17.2 | 17.3 |
| % | PEG 8000 | 4.4 | 4.0 | 4.4 | 4.5 |
| % | Imwitor 372 C | 1.9 | 1.7 | 1.9 | 1.9 |
| % | Sulfentrazone | 6.2 | 5.6 | 6.2 | 6.2 |
| % | CaCO3 | 70.3 | 18.1 | 56.2 | 0.0 |
| % | NaHCO3 | 0.0 | 0.0 | 14.0 | 0.0 |
| % | Citric acid | 0.0 | 55.0 | 0.0 | 70.1 |

The individual formulations are poured on a plate, air dried for 3 h, and then oven dried over night. The resulting solids are broken in a mortar and sieved to sizes of 150-500 μm, 80-150 μm, and <80 μm.

Extraction was carried out by the mixed protocol of example 1

12. Formulations of Sulfentrazone in PEG modified Acetylcellulose on Calcium carbonate and Citric acid. (076). Acetylcellulose, PEG 8000, and Sulfentrazone are suspended in Methanol, and filled up with a halogenated solvent to the given volume. The carrier is added and thoroughly disperged. A sample of the slurry is poured on a plate, the rest poured into a vessel with approx. 58 cm2 of area to result in a dry cake of approx. 2.5 mm thickness. The samples are air dried over night, and then oven dried at 60° C. for 48 h. Of the pairs, the first letter represents the thin film, the second letter the thick preparation.

| | 25 | a, b | 25 | c, d | 25 | e, f | 27 | g, h |
|---|---|---|---|---|---|---|---|---|
| ml/entry | mg | % | mg | % | mg | % | mg | % |
| Acetylcellulose | 2513 | 7.4 | 2508 | 7.4 | 2530 | 7.5 | 2504 | 7.4 |
| PEG 8000 | 639 | 1.9 | 651 | 1.9 | 640 | 1.9 | 647 | 1.9 |
| Sulfentrazone | 1126 | 3.3 | 1095 | 3.2 | 1110 | 3.3 | 1095 | 3.2 |
| tech. | | | | | | | | |
| Sulfentrazone | 1040 | 3.1 | 1012 | 3.0 | 1026 | 3.0 | 1012 | 3.0 |
| pure | | | | | | | | |
| CaCO3 | 29500 | 87.3 | 8600 | 25.4 | 8504 | 25.2 | 8500 | 25.2 |
| citric acid | 0 | 0.0 | 20950 | 62.0 | 21000 | 62.2 | 21000 | 62.2 |
| total | 33778 | | 33804 | | 33784 | | 33746 | |
| MeOH [ml] | ca 8 | | ca 8 | | 2.5 | | 7.5 | |
| CH₂Cl₂ [ml] | ca 15 | | ca 15 | | ca 20 | | 0 | |
| CHCl₃ [ml] | 0 | | 0 | | 0 | | ca 17 | |

In entries c,d,e, and f, crystalline citric acid is used, in entries g, and h, micronized citric acid is applied. The resulting solids are broken in a mortar and sieved to sizes of 150-500 μm, 80-150 μm, and <80 μm.

Extractions were carried out according to the mixed procedure in example 1. All formulations lead to 100% extraction by 24 h

13 Formulation of Sulfentrazone in Urotropin Modified Acetylcellulose (073)

2.1 g of acetylcellulose and 700 mg of urotropin are suspended in approx. 5 ml of methanol, and dissolved with dichloromethane to yield 15 ml total. An aliquot of 5 ml is taken, and augmented with 258 mg of sulfentrazone. When everything is dissolved, 3.3 g of CaCO3 are added and thoroughly suspended. The slurry is poured on a plate, air dried for 3 h and then oven dried for 15 h. The resulting solids are broken in a mortar and sieved to sizes of 150-500 m, 80-150 μm, and <80 μm.

The formulation contains 4.8% of urotropin, 14.3% of acetylcellulose, 5.4% of sulfentrazone, and 75% of CaCO3 by calculation.

Extractions were carried out according to the general procedure

14 Formulation of Sulfentrazone in Urotropin Modified Aceteylcellulose (079)

Acetylcellulose, urotropin, and sulfentrazone are suspended in methanol and dissolved by addition of dichloromethane. CaCO3 is added and thoroughly dispersed. The resulting slurry is poured on a plate and air dried for 3 h, then oven dried at 60° C. for 18 h.

| | entry | a | b | c | d | e | f | g | h | i |
|---|---|---|---|---|---|---|---|---|---|---|
| mg | Acetylcellulose | 1084 | 1030 | 1006 | 773 | 754 | 761 | 603 | 616 | 605 |
| mg | Urotropin | 118 | 254 | 438 | 85 | 189 | 334 | 69 | 153 | 260 |
| mg | CaCO3 | 2743 | 2898 | 3214 | 3397 | 3720 | 4287 | 6334 | 7280 | 8180 |
| mg | Sulfentrazone | 270 | 288 | 322 | 293 | 325 | 374 | 482 | 549 | 624 |
| % | Acetylcellulose | 26.1 | 23.2 | 20.3 | 17.1 | 15.2 | 13.3 | 8.1 | 7.2 | 6.3 |
| % | Urotropin | 2.8 | 5.7 | 8.8 | 1.9 | 3.8 | 5.8 | 0.9 | 1.8 | 2.7 |
| % | CaCO3 | 66.0 | 65.3 | 64.9 | 75.1 | 75.0 | 74.9 | 85.1 | 85.1 | 85.2 |
| % | Sulfentrazone | 6.0 | 6.0 | 6.0 | 6.0 | 6.1 | 6.0 | 6.0 | 5.9 | 6.0 |
| ml | CH3OH | 2 | 2 | 2 | 2 | 2 | 2 | 2 | 2 | 2 |
| ml | CH2Cl2 | 2.1 | 2.67 | 2.68 | 3 | 3 | 3 | 4 | 4 | 4 |

The resulting solids are broken in a mortar and sieved to sizes of 150-500m, 80-150 μm, and <80 μm. Extractions were carried out according to the mixed procedure of example 1

TABLE
Extraction efficacy of Formulations 13 after 1 day and 5 days

| | a | b | c | d | e | f | g | h | i |
|---|---|---|---|---|---|---|---|---|---|
| 1 day | 92 | 54 | 74 | 78 | 41 | 45 | 49 | 35 | 43 |
| 5 days | 101 | 90 | 89 | 95 | 76 | 82 | 76 | 65 | 73 |

15. Formulation of Sulfentrazone in Polyvinylacetate-Polyvinylpyrrolidone (082)

2053 mg of Kollidon (r) SR are suspended in 3 ml of methanol and soon chloroform is added to make up to 20 ml. 1077mg of sulfentrazone are added. The mixture is shaken, and when a clear solution is formed, aliquots are taken and equipped with carrier.

| | entry | a | b | c |
|---|---|---|---|---|
| ml | stock | 5.0 | 4.8 | 4.7 |
| mg | Kollidon | 513 | 493 | 482 |
| mg | Sulfentrazone | 269 | 258 | 253 |
| mg | CaCO3 | 3147 | 775 | |
| mg | Citric acid | | 2324 | |
| mg | starch | | | 2901 |
| % | Kollidon | 13.1 | 12.8 | 13.3 |
| % | Sz pure | 6.3 | 6.2 | 6.4 |
| % | CaCO3 | 80.1 | 20.1 | |
| % | citric acid | | 60.4 | |
| % | starch | | | 79.8 |

Other possible combinations of active ingredients in different matrices may be produced by dissolution in the following solvents (ABC, acetyl, butaryl cellulose, ACC, acetyl cellulose, PMMA, polymethacrylate, PS, polystyrene, PVA, polyvinyl alcohol):

| | ABC | ACC | Collodion | PMMA | PS | PVA |
|---|---|---|---|---|---|---|
| Sulfentrazon | Acetone | | | DCM | Acetone | |
| Azoxystrobin | Acetone | Ethylacetate | | | | THF |
| Flutriafol | Acetone | | | | | THF |
| Atrazin | Acetone | | | | | Chloroform |
| Hexazinon | Acetone | Ethylacetate | | | | |
| Terbuthylazin | Acetone | Acetone | | | | |
| Quinclorac | | | | | | |
| Imazapyr | Acetone | | | DCM | | |
| Imazamox | Acetone | | | DCM | | |
| Cartap | | | | | | water |
| Carbofuran | | | | | | |
| Clothianidin | | | | | | |
| Bromacil | | | | DCM | | |
| Glyphosat | | | | | | water |
| Carbosulfan | | | | | Toluene | |
| Metazachlor | Acetone | | | | | |
| Dicamba | | Ethylacetate | | | | |
| 2,4-D | | Ethylacetate | | | | |
| Acetamiprid | | Ethylacetate | | | | |
| Chlorthalonil | | | | | | |
| Diuron | | | Acetone | | | |
| Mesotrion | Acetone | | | | | THF |
| Metribuzin | | Ethylacetate | | | | THF |
| Metamifop | Acetone | Ethylacetate | | | Acetone | |
| Clodinafop | Acetone | | | | | |
| Clomazone | Acetone | Ethylacetate | | | Acetone | |
| Trifluralin | | | | | Toluene | |
| Imidacloprid | | | | | | |
| Carfentrazon | Acetone | Ethylacetate | | DCM | Toluene | |

### Example 16

0.61 g PMMA, 0.15 g PEG 8000, 0.24 g Sulfentrazone is dissolved in 9 ml CHCl₃/Acetone (1/1), poured on a glass plate and dried at 60° C. The solid formulation is ground and fractionated to 500−150 μm, 150−80 μm, 80−50 μm, <50 μm.

Example 17 0.61 g PMMA, 0.15 g PEG 8000, 0.24 g Sulfentrazone is dissolved in 9 ml CHCl₃/Acetone (1/1). To this solution 7 g finely ground CaCO₃ are added, mixed, poured onto a glass plate and dried at 60° C. to form a film. The solid film formulation is ground and fractionated to 500−150 μm, 150−80 μm, 80−50 μm, <50 μm.

Example 18, A mixture of finely ground NaHCO₃ and citric acid is mixed with 0.12 g Clomazone, 0.18 g Metaupon or sulfentrazone according to the proportions in the following table. To this mixture, formulation from ex. 17 (<50 μm) is added. The formulation is pressed to granules with 0.4 and 0.3 mm Ø.

| | finely | | | Leunapon | Form- | | |
|---|---|---|---|---|---|---|---|
| Agent/ | ground | Citric | PEG | F | ulation | | |
| example | NaHCO₃ | acid | 400 | 1618/25 | ex. 17 | Clomazone | Metaupon |
| 1 | 2.1 | 1.6 | 0.3 g | | 2 g | | |
| 2 | 2.1 | 1.6 | 0.15 g | 0.15 g | 2 g | | |
| 3 | 2.1 | 1.6 | 0.18 g | 0.18 g | 2 g | 0.12 g | 0.12 g |
| 4 | 2.1 | 1.6 | | | 2 g | 0.12 g | 0.18 g |

Example 19, 5.3 g PMMA, 2.3 g PEG 8000, 2.4 g Sulfentrazone is dissolved in 90 ml CHCl₃/Acetone (1/1). To this solution 1.47 g finely ground CaCO₃ and 5.53 potassium hydrogen tartrate are added, mixed, poured onto a glass plate and dried at 60° C. The solid formulation is ground and fractionated to 500−150 μm, 150−80 μm, 80−50 μm, <50 μm.

Example 20, 2.7 g of a mixture of NaHCO₃ (4.2 g) and citric acid (3.2 g) is mixed with 0.3 g Metaupon OMT. 1.0 g formulation from ex. 12 with different particle size is added and then pressed to granules with 0.4 and 0.3 mm Ø:

| | Particle Size | Diameter |
|---|---|---|
| Formulation | [μm] | [mm] |
| A | 500-150 | 0.4 |
| B | 500-150 | 0.3 |
| C | 150-80 | 0.4 |
| D | 150-80 | 0.3 |
| E | 80-50 | 0.4 |
| F | 80-50 | 0.3 |

Example 21, Granular formulations of A-F were taken according to the standing system in example 1. Samples were taken in all 4 corners at a distance of approx. 10 cm from the edges. Bottom (“U”) and top (“O”) samples were taken. The values were corrected for the loss of water during the sampling period. Values above 100% total extraction represent initial in-homogeneities due to convection in one preferred direction.

Example 21. A mixture from PMMA, PEG 8000 and Sulfentrazone in the amounts as set forth in the following table is dissolved in 10 ml CHCl₃/Acetone (1/1) per g dry weight. The resulting solution is poured onto a glass plate and dried at 60° C.

| Formulation 21.; | 14 | 15 | 16 | 17 | 18 | 19 | 20 | 21 | 22 | 23 | 24 |
|---|---|---|---|---|---|---|---|---|---|---|---|
| PMMA | 83 | 75 | 67 | 58 | 50 | 42 | 33 | 25 | 17 | 8 | 0 |
| PEG 8000 | 0 | 8 | 17 | 25 | 33 | 42 | 50 | 58 | 67 | 75 | 83 |
| Sulfentrazone | 17 | 17 | 17 | 17 | 17 | 17 | 17 | 17 | 17 | 17 | 17 |

### Example 22

1 g formulation from examples 14-24 is dissolved in 2 ml CHCl₃/Acetone (1/1). To this solution 7 g finely ground CaCO₃ is added and thoroughly mixed. The slurry is poured onto a glass plate and dried at 60° C. The solid formulation is ground and fractionated to 500−150 μm, 150−80 μm, 80−50 μm, <50 μm.

| Formulation 22.: | 25 | 26 | 27 | 28 | 29 | 30 | 31 | 32 | 33 | 34 | 35 |
|---|---|---|---|---|---|---|---|---|---|---|---|
| pmma | 83 | 75 | 67 | 58 | 50 | 42 | 33 | 25 | 17 | 8 | 0 |
| peg | 0 | 8 | 17 | 25 | 33 | 42 | 50 | 58 | 67 | 75 | 83 |
| sz | 17 | 17 | 17 | 17 | 17 | 17 | 17 | 17 | 17 | 17 | 17 |
| | 1 | 1 | 1 | 1 | 1 | 1 | 1 | 1 | 1 | 1 | 1 |
| CaCO3 | 7 | 7 | 7 | 7 | 7 | 7 | 7 | 7 | 7 | 7 | 7 |

Example 23, Finely ground ammonium sulfate (3 g) is mixed with 1.5 g ground formulation (150−80 μm) from example 19 and pressed to pellets with 0.4 and 0.3 mm Ø.

Example 20, Finely ground urea (3 g) is mixed with 1.5 g ground formulation (150−80 μm) from ex. 12 and pressed to pellets with 0.4 and 0.3 mm Ø.

Example 21, A mixture from acetyl cellulose, PEG 8000, urotropin and Sulfentrazone in the amounts as set forth in the following table is dissolved in 10 ml CHCl₃/Acetone (1/1) per g dry weight. The resulting solution is poured onto a glass plate and dried at 60° C.

| Formulation | A | B |
|---|---|---|
| ACC | 79 | 75 |
| PEG 8000 | 2 | 4 |
| urotropin | 2 | 4 |
| Sulfentrazone | 17 | 17 |

### Example 22

1 g formulation from examples 38, 39 is dissolved in 2 ml CHCl₃/Acetone (1/1). To this solution 7 g finely ground CaCO₃ or 5 g CaCO₃ and 2 g starch is added and thoroughly mixed (see table). The slurry is poured onto a glass plate and dried at 60° C.

The solid formulation is ground and fractionated to 150−80 μm, 80−50 μm, <50 μm.

| Formulation | A | B | C | D |
|---|---|---|---|---|
| ACC | 79 | 79 | 75 | 75 |
| PEG 8000 | 2 | 2 | 4 | 4 |
| urotropin | 2 | 2 | 4 | 4 |
| Sulfentrazone | 17 | 17 | 17 | 17 |
| CaCO₃ | 700 | 500 | 700 | 500 |
| starch | | 200 | | 200 |

### Example 23

The relevant amount of the respective formulation is weighed into a Falcon tube such as to receive a final concentration in Sulfentrazone of 10 μg/ml. As an extraction medium 40 ml of water were used.

Example 24. Granule formulation of trifluralin. Granulated fertiliser of the type xxx contaning primarily superphosphate is treated with a solution comprising acetyl cellulose, trifluralin, metolachlor and clomazone, respectively, 25, 10, 15 and 8 g/L in dichloromethane. The solvent mixture is added at the rate of 90 mL/kg fertiliser in a rotating drum over several minutes with rotation and stirring. The resulting granules are dried with solvent recovery. The yellow granules are suitable for broadcast application at the rate of 50 to 150 kg/ha.

Example 25 Preparation of granules of carfentrazone and propanil in pummus. Pummus, is mixed 8:1 with water containing 2% methylcellulose, and a suspension of carfenrazone 5 g/kg pummus, and propanil 15 g/kg pummus. The mixture is extruded at a diameter of 3 mm and dried. Application is at 30 to 45 kg/ha :

Example 26 Biodac granules are modified to contain sulfentrazone by mixing 1 kg of biodac 12/20 granules with 500 mL of chloroform containing 100 g of acetylbutarylcellulose, and 2 g, 5 g, or 20 g sulfentrazone. The mixture is concentrated i.v., and allowed to dry at atmospheric pressure. Application is at 30 to 60 kg/ha.

The Procedure can be applied to a variety of other combinations of “carrier” (here: biodac), “binder” (here: Acetylbutyrylcellulose) and “solvent” (here: chloroform)

| Entry | Solvent | Binder | Carrier |
|---|---|---|---|
| 1 | Aceton | Celluloseacetate | Biodac |
| 2 | Aceton/Methanol | Poly(methylmeth- | Biodac |
| | (1 + 1) | acrylate) | |
| 3 | water (pH 10 by | Polyvinylalcohol | Biodac |
| | Na2CO3) | | |
| 4 | Aceton/Methylacetate | Polyvinylacetate | Biodac |
| 5 | Dichloromethane/ | Cellulose butyrate | Perlite |
| | Methanol (9 + 1) | acetate | |
| 6 | Acetone | Polystyrene | Eco-Granule HW |
| 7 | ethyl acetate | Poly(methylmeth- | Bentonite |
| | | acrylate) | |
| 8 | Tetrahydrofurane | Polystyrene | Vermiculite |
| 9 | Acetone | Polyvinylchlorid | Eco-Granule LT |
| 10 | Toluene | Polystyrene | Perlite |
| 11 | Acetone | Polyvinylacetate | Wood chips |
| 12 | Water | Methylcellulose | Superphosphate |
| 13 | Water | Hypromellose | Dolomite |
| 14 | Acetone | Nitrocellulose | Biodac |

| | | | % | | |
|---|---|---|---|---|---|
| | | | Sulfentra | | |
| entry | carrier | binder | zone | solvent | |
| 1 | Biodac ® | 2% Polyvinylacetate | 1 | Acetone | |
| | 20/50 | | | | |
| 2 | Biodac ® | 2% Poly- | 1 | Acetone | |
| | 12/20 | methylmethacrylate) | | | |
| 3 | Biodac ® | 2% Polyvinylalcohol | 1 | Acetone | |
| | 8/16 | | | | |
| 4 | Biodac ® | 3.3% Acetylcellulose | 0.5 | Dichloromethane/ | |
| | 12/20 | (MW 30 000) | | Methanol 95:5 | |
| 5 | Biodac ® | 3.3% Acetylcellulose | 0.5 | Dichloromethane- | vacuum |
| | 12/20 | (MW 30 000) | | Methanol 95-5 | treated |
| 6 | Biodac ® | — | 1 | Cyclohexane- | |
| | 12/20 | | | Dichloromethane- | |
| | | | | Methanol 90-8.5-1.5 | |
| 7 | Biodac ® | 2% Acetylcellulose | 1 | Dichloromethane- | contains |
| | 12/20 | (MW 30 000) | | Methanol 75-5 | 0.7% |
| | | | | | NaOMe |
| 8 | Biodac ® | 1.3% Acetylcellulose | 0.7 | Dichloromethane- | contains |
| | 12/20 | (MW 30 000) | | Methanol 75-5 | 0.5% |
| | | | | | NaOMe |
| 9 | Biodac ® | 2% Acetyl-butyroyl- | 1 | Ethylacetate | |
| | 12/20 | cellulose | | | |
| | | (MW 12 000) | | | |
| 10 | Biodac ® | 2% Polystyrene | 1 | Ethylacetate | |
| | 12/20 | | | | |
| 11 | Biodac ® | 1.3% Acetyl- | 0.7 | Acetone | |
| | 12/20 | butyroyl-cellulose | | | |
| | | (MW 12 000) | | | |
| 12 | Vermiculite | 5.3% Acetyl-butyroly- | 2.7 | Acetone | |
| | | cellulose | | | |
| | | (MW 12 000) | | | |
| 13 | Vermiculite | 2.6% Acetylcellulose | 1.3 | Acetone | |
| 14 | Pumice fine | 6% Acetyl-butyroly- | 1.5 | Acetone | Particles |
| | | cellulose | | | sieved to |
| | | (MW 12 000) | | | 0.15- |
| | | | | | 2 mm |
| 15 | Pumice | 6% Acetyl-butyroyl- | 1.5 | Acetone | Particles |
| | coarse | cellulose | | | approx. |
| | | (MW 12 000) | | | 1 cm |
| 16 | Pumice | 6% Acetyl-butyroyl- | 1.5 | Acetone | from 15 |
| | powder | cellulose | | | mortared |
| | | (MW 12 000) | | | to << |
| | | | | | 50 μm |

The release profile is measured by placing an equivalent of 100 to 150 mg of formulation into a vial, adding 10 ml of water and sampling after i.e. 5, 10, 15, 20, 25, 30, 40, 50, 60, 90 and 960 min 4000 of the solution/suspension. The samples are immediately centrifuged and an aliquot is separated and anlalysed by HPLC-MS.

### Example 27 Formulation of Sulfentrazone in Mixtures of Methylcellulose and Acetyl Butyroyl Cellulose

Sulfentrazone is dissolved in 20 ml of Chloroform. Methylcellulose and Acetyl butyroyl cellulose are added, and left soaking for 20 min. 3 ml of Methanol are added, and the mixture is shaken vigurously. The formulation is dried on a plate at room temperature for 5 h and then at 60° C. for 24 h.

| entry | a | b | c |
|---|---|---|---|
| Sulfentrazone (92.4%) | 59.1 mg | 56.6 mg | 59.8 mg |
| Sulfentrazone (pure) | 54.6 mg | 52.3 mg | 55.3 mg |
| Methylcellulose | 2277 mg | 1890 mg | 1610 mg |
| Acetyl butyroyl cellulose | 201 mg | 449 mg | 757 mg |
| % Sulfentrazone | 2.2 | 2.2 | 2.3 |
| % Methylcellulose | 89.9 | 79 | 66.5 |
| % Acetyl butyroyl cellulose | 7.9 | 18.8 | 31.3 |

### Example 28, Formulation of Sulfentrazone with Sodium Alginate, Calcium Sulfate, Hypromellose, and Polyacrylic Acid

Sulfentrazone is dissolved in 20 ml of dichloromethane. Sodium alginate and hypromellose are added and left soaking for 20 min. Anhydrous calcium sulfate is added and distributed thoroughly in the mixture. Polyacrylic acid is added as a 10% Solution in methanol, and the mixture is very vigourously mixed for at least 15min to ensure homogenous distribution of all components. Then the mixture is brought into the desired form (adequate viscosity can be achieved by addition or evaporation of dichloromethane) and dried, first at room temperature for 5 h, then at 60° C. for at least 24 h.

| Entry | a | b |
|---|---|---|
| Sulfentrazone (92.4%) | 71 mg | 99.3 mg |
| Sulfentrazone (pure) | 65.6 mg | 91.8 mg |
| Sodium alginate | 512 mg | 276 mg |
| Hypromellose | 252 mg | 142 mg |
| Calcium sulfate | 784 mg | 420 mg |
| Polyacrylic acid | 100 mg | 100 mg |
| % Sulfentrazone | 3.8 | 8.9 |
| % Sodium alginate | 29.9 | 26.8 |
| % Hypromellose | 14.7 | 13.8 |
| % Calcium sulfate | 45.8 | 40.1 |
| % Polyacrylic acid | 5.8 | 9.7 |

### Example 29, Formulation of Sulfentrazone in Acetylcellulose with Calcium Sulfate Filling

272 mg of acetylcellulose are wetted with lml of methanol, and a solution of 66 mg of sulfentrazone (92.4%, 61 mg of pure compound) 12 ml of chloroform is added. 546 mg of anhydrous calcium sulfate are added, and the mixture is vigurously mixed to ensure homogenous distribution of all components. The mixture is pured on a plate and dried, first at room temperature for 5 h, then at 60° C. for at least 24 h. The preparation can be broken into pieces and sieved to the desired size.

Example 30, Formulation of Sulfentrazone in Acetyl butyroyl cellulose with Calcium sulfate and Phosphomolybdic acid. 1920mg of acetyl butyroyl cellulose are wetted with 2.5 ml of methanol, and dissolved by addition of 8 ml of acetone. 428 mg of sulfentrazone (tech., 92.4%=395 mg pure sulfentrazone) are added and dissolved. 137 mg of phosphormolybdic acid are added and dissolved. 6160 mg of anhydrous calcium sulfate are added and distributed by heavy shaking. The solvent is removed by evaporation i.v. The resulting mass can be brought into a desired form by wetting with acetone, or it can be ground and sieved to a powder.

Example 31, Formulation of Sulfentrazone in Acetyl cellulose with a water soluble Filler. 123 mg of sulfentrazone (tech., 92.4% =114 mg of pure compound) are dissolved in 12 ml of chloroform. 600 mg of acetyl cellulose are added. The mixture is vigurously shaken until homogenous. 2000 of methanol are added, and the mixture is shaken again. 2083 mg of finely powdered ammonium sulfate are added. The mixture is homogenised, poured on a plate and dried for 3 day at room temperature.

Example 32, Formulation of Sulfentrazone in Acetyl cellulose for use in spray application. 123 mg of sulfentrazone (tech., 92.4%=114 mg of pure compound) are dissolved in 20 ml of dichloromethane. 990 mg of acetyl cellulose are added. The mixture is vigurously shaken until homogenous. The clear fluid is evaporated as a film which should remain transparent on drying. The dried film is mechanically broken up and ground to mean particle size of 20 μm. The ground mixture constitutes the sub-particles.

The mixture is applied by mixing with spray water in the range of 2 kg/100 L. A non-inonic surfactant may be used in the range of 0.01% W/V.

Example 33, Formulation of Sulfentrazone in Acetyl cellulose for use in spray application. 120 mg of sulfentrazone are dissolved in 10 ml of dichloromethane. 480 mg of acetyl cellulose are added. The mixture is vigurously shaken until homogenous. The clear fluid is evaporated as a film which should remain transparent on drying. The dried film is mechanically broken up and ground to mean particle size of 20 μm. The ground mixture constitutes the sub-particles. The mixture is applied by mixing with spray water in the range of 1 kg/100 L. A non-inonic surfactant may be used in the range of 0.01% WN. The sub particles may be mixed with 100 g talc containing 10% halosulfuron. The mixure is brought to 1.1% in a spray solution and applied using a laboratory sprayer at the rate of 100 L/ha equivalent.

Example 34, tolerance testing in soybeans. Seeds are germinated in potting soil and when emerged are transferred to 500 mL pots, 4 per pot. At the first true leaf stage, pots are sprayed using a laboratory spray at the calibrated rate of 100 L/ha. Plants are treated with the mixture from examples 32 or 33. Plants are sprayed with technical or formulated sulfentrazone at 25, 50, 100 and 200 g/ha. After 4 and 14 days, plants are scored for injury by visual estimate using 3 blinded observers.

| | Rate g/ha | | | | |
|---|---|---|---|---|---|
| | Example | | | | |
| | 0 | | | | |
| | % injury | | | | |
| | at 14 days | 25 | 50 | 100 | 200 |
| Technical | 0 | 24 | 39 | 80 | 98 |
| 20% sub-particle | 0 | 10 | 15 | 32 | 41 |
| 10% sub-particle | 0 | 10 | 12 | 30 | 45 |
| 10% plus sulfonylurea | 0 | 16 | 22 | 25 | 36 |

Example 35, Formulation of Sulfentrazone in acetyl cellulose for use in granule application. 1000 mg of sulfentrazone are dissolved in 100 ml of dichloromethane. 9 g of acetyl cellulose are added. The mixture is vigurously shaken until homogenous and then allowed to evaporate under light heating until it becomes viscous. 1 g of anhydrous calcium sulfate is added and the mixture allowed to further dry with agitation and grinding to form sub-particles of approximately 0.5 to 1 mm in diameter. The dried sub-particles are mixed with a dispersable granulation matrix (pumice, lignin sulfate, cellulose ammonium sulfate 8:1:1:1) at a rate of 50 g sub-particles per kg granulation mixture. Granules were extruced in 4 mm diameter, ca 8 mm in length.

Example 36, Formulation of Sulfentrazone in acetyl cellulose for use in granule application. 1000 mg of sulfentrazone are dissolved in 100 ml of dichloromethane. 9 g of acetyl cellulose are added. The mixture is vigourously shaken until homogenous and then allowed to evaporate under light heating until it becomes viscous. 1 g of urea and 200 mg of phosphormolybdic acid is added and the mixture allowed to further dry with agitation and grinding to form sub-particles of approximately 0.5 to 1 mm in diameter. The dried sub-particles are mixed with a dispersable granulation matrix (pumice, lignin sulfate, cellulose ammonium sulfate 7:1:1:1) at a rate of 50 g sub-particles per kg granulation mixture. Granules were extruded in 4 mm diameter, ca 8 mm in length.

Example 37, Formulation of Sulfentrazone in acetyl cellulose for use in granule application. Granules containing sulfentrazone are made as above but without the addition of a water soluble salt such as urea or calcium sulfate. The resulting sub-particles are then divided and further mixed as follows.

Technical clomazone is dissolved in acetone in a ratio 5:1 clomazone:polystyrene and added to pumice to a final concentration of 1.4% clomazone. The material is well mixed and allowed to dry before pumice is mixed with lignin sulfate, cellulose and ammonium sulfate to form the granulation mix above.

Technical carfentrazone is dissolved in toluene in a ratio 5:1 carfentrazone:polystyrene and added to pumice to a final concentration of 0.2%. The material is well mixed and allowed to dry before pumice is mixed with lignin sulfate, cellulose and ammonium sulfate to form the granulation mix above.

From these components the following mixtures are made. Sulfentrazone sub-particles 10 g are mixed with 90 g of the clomazone containing granulation mix. To this mix may be added 0.7 g of halosulfuron or 0.45 g bispyribac-sodium. The mixture is mixed exhaustively and extruded as 4 mm granules.

The same mixture is repeated with the carfentrazone containing granulation mix.

The overall concept is illustrated in the diagram below where sulfentrazone is herbicide A. and Herbicide B is either halosulfuron or bispyribac-sodium

### Example 38 Tolerance Testing in Rice

To monitor the release of active ingredient, the standing paddy system of example 1 is employed. The trays for this paddy simulation are approximately 0.1 m2 and 100 mg of granules approximates 10 kg of granules per ha.

To monitor rice tolerance, rice seedlings are germinated for 7 days at 26 C and then transferred to a loose potting mix with adequate water. When the plants are approximately 20 cm high, they are transplanted in approximately 5×5 cm patches containing ca. 6 to 8 plants to a 4 L tray as used for release studies. Water volume is maintained at approximately 4 L by topping up water levels every second day to a mark made at 4L.

Two days after transplanting seedlings, granules are supplied in the following amounts: 10, 25, 50 75 100 and 150 mg which approximates to 10, 25, 50 75 100 and 150 g/ha sulfentrazone equivalent.

Rice seedlings are evaluated when there is a clear difference between the most damaged tray and the untreated control, typically at 3, 7 and 14 days after treatment.

| | Rate sulfentrazone g/ha/ | | | | | | |
|---|---|---|---|---|---|---|---|
| | 0 | 10 | 25 | 50 | 75 | 100 | 150 |
| Example: | % injury at 14 days | | | | | | |
| Technical | 0 | 30 | 50 | 70 | 80 | 90 | 100 |
| sulfentrazone | | | | | | | |
| 1% granule, CaSO4 | 0 | 0 | 0 | 10 | 20 | 20 | 40 |
| 1% granule, Urea | 0 | 10 | 10 | 30 | 30 | 40 | 40 |
| 1% granule, CaSO4, | 0 | 10 | 10 | 35 | 30 | 45 | 45 |
| clomazone | | | | | | | |
| 1% granule, | 0 | 10 | 10 | 25 | 30 | 40 | 40 |
| clomazone | | | | | | | |
| 1% granule, | 0 | 10 | 10 | 20 | 30 | 35 | 40 |
| Carfentrazone | | | | | | | |
| 1% granule, | 0 | 10 | 10 | 30 | 30 | 40 | 50 |
| clomazone, | | | | | | | |
| Halo sulfuron | | | | | | | |
| 1% granule, | 0 | 10 | 10 | 20 | 30 | 40 | 40 |
| Carfentrazone, | | | | | | | |
| bispyribac | | | | | | | |

Example 38 Granules can be prepared as for example 26 using other ingredients as follows:

| entry | a.i. | binder | carrier | solvent | comment |
|---|---|---|---|---|---|
| 1 | Sulfentrazone | ABC | Biodac | Dichloromethane | 1b |
| 2 | Sulfentrazone | Collodium | Vermiculite | Acetone | 1a |
| 3 | Azoxystrobin | ACell | Biodac | Ethylacetate | 2c |
| 4 | Azoxystrobin | Polyvinylacetate | Vermiculite | THF | 2d |
| 5 | Flutriafol | ABC | Biodac | Acetone | 3a |
| 6 | Atrazine | ABC | Biodac | Acetone | 4a |
| 7 | Atrazine | Polyvinylacetate | Vermiculite | Chloroform | 4e |
| 8 | Hexazinone | ACell | Biodac | Ethylacetate | 5c |
| 9 | Terbuthylazine | ACell | Vermiculite | Acetone | 6a |
| 10 | Imazapyr | PMMA | Biodac | Dichloromethane | 8b |
| 11 | Imazamox | PMMA | Biodac | Dichloromethane | 9b |
| 12 | Cartap | Polyvinylalcohol | Ca-silicit | Water | 10i |
| 13 | Bromacil | PMMA | Biodac | Dichloromethane | 13b |
| 14 | Glyphosate | Polyvinylalcohol | Ca-silicit | Water | 14i |
| 15 | Carbosulfan | Polystyrene | Ca-silicit | Toluene | 15m |
| 16 | Metazachlor | ABC | Biodac | Acetone | 16a |
| 17 | Dicamba | ACell | Biodac | Ethylacetate | 17c |
| 18 | Acetamiprid | ACell | Biodac | Ethylacetate | 18c |
| 19 | Diuron | Collodium | Ca-silicit | Acetone | 21a |
| 20 | Mesotrion | ABC | Biodac | Acetone | 22a |
| 21 | Metribuzin | ACell | Biodac | Ethylacetate | 23c |
| 22 | Metamifop | ABC | Biodac | Acetone | 24a |
| 23 | Metamifop | ACell | Biodac | Ethylacetate | 24c |
| 24 | Metamifop | Collodium | Vermiculit | Acetone | 24a |
| 25 | Metamifop | Polystyrene | Vermiculit | Toluene | 24m |
| 26 | Clodinafop | ABC | Biodac | Acetone | 25a |
| 27 | Clomazone | ABC | Biodac | Acetone | 26a |
| 28 | Clomazone | ACell | Biodac | Ethylacetate | 26c |
| 29 | Clomazone | Collodium | Vermiculite | Acetone | 26a |
| 30 | Clomazone | Polystyrene | Vermiculite | Toluene | 26m |
| 31 | Trifluraline | Polystyrene | Ca-Silicit | Toluene | 27m |
| 32 | Carfentrazone- | PMMA | Biodac | Dichloromethane | 29b |
| | ethyl | | | | |
| 33 | Carfentrazone- | ACell | Biodac | Ethylacetate | 29c |
| | ethyl | | | | |
| 34 | Carfentrazone- | ABC | Ca-silicite | Acetone | 29a |
| | ethyl | | | | |
| 35 | Carfentrazone- | Polystyrene | Ca-silicite | Toluene | 29m |
| | ethyl | | | | |

ABC = Acetyl-butyroyl-cellulose
PMMA = Poly-(methyl-methacrylate)
ACell = Acetylcellulose
Ca-silicit = Katzenstreu

The availability of the active ingredients is shown by extraction with water as per example 1:

Example 39, 100 g of Biodac® cellulose granules (12/20) were soaked with a solution of 0.21 g Cycloxaprid and 1.89 g acetyl butyryl cellulose in 50 ml acetone/dichloromethane (1:1, v/v) and dried under reduced pressure. The resulting granules have an a.i. content of 0.2%.

Example 40, 100 g of Biodac® cellulose granules (12/20) were soaked with a solution of 0.42 g Clothianidin and 1.64 g acetyl cellulose in 50 ml acetone/dichloromethane (1:1, v/v) and dried under reduced pressure. The resulting granules have an a.i. content of 0.4%.

Example 41, 120 g of Biodac® cellulose granules (12/20) were soaked with a solution of 0.5 g Cycloxaprid and 4.5 g nitro cellulose in 100 ml acetone/dichloromethane (1:1, v/v) and dried under reduced pressure. The resulting granules have an a.i. content of 0.4%.

Example 42, 8.28 g of pumice powder (<90 μm) are mixed with 5.4 g of a solution of 160 mg of Sulfentrazone and 800 mg of acetyl-butyroyl-cellulose (MW 12 000) in THF. The resulting paste is diluted with Acetone, until it can be extruded with a syringe through a luer-fitting. A worm like structure is formed this way and left drying at air. The extrudate is cut into pieces of approx. 1-3 mm length.

The release profile is measured as in example 1

### Example 43

The procedure of example 8 is applied with powdered glucose instead of pumice

### Example 44

The procedure of example 8 is applied with talc instead of pumice

Example 45, Reduction of phytotoxicity of carfentrazone using a sulfonylurea. Rice seedlings are allowed to germinate for 5 days and are then transplanted to pots and allowed to reach the 2-3 leaf stage. Carfentrazone is mixed with metsulfuron (10 μg/plant) and applied in a droplet to the leaf axil of the largest fully expanded leaf.

Example 46: Preparation of a slow release formulations of sulfentrazone via melt 6.1 g of commercial sulfentrazone (92.4%) and 3.72 g of cellulose acetate butyroate (Mn=12000) are mixed and heated to 155° C. The mixture is stirred with a strong stirrer and continuous heating, until a homogeneous, transparent solution is formed (ca. 1 h). The material is left cooling as a thin film, or is sprayed via a nitrogen stream into particles.

Example 47: 24.1 g of commercial sulfentrazone (92.4%) are melted. 14.6 g of cellulose acetate butyroate (Mn=12000) are added and the mixture is stirred with a strong stirrer and continuous heating, until a homogeneous, transparent solution is formed. 0.79 g of stearylamine are added and stirring and heating are continued until a homogenious solution is formed. The material is cooled as in example 46.

Example 48 13.3 g of technical sulfentrazone (92.4%) and 8.1 g of cellulose acetate butyroate (Mn=12000) are thoroughly mixed. The mixture is heated to 140° C. and stirred with a strong stirrer and continuous heating, until a homogeneous, transparent solution is formed. 0.44 g of technical tallowamine (Noram SH, CECA) are added and stirring and heating are continued until a homogeneous solution is formed. The material is left cooling as in example 46.

Example 49 9.6 g of commercial sulfentrazone (92.4%), 5.78 g of cellulose acetate (Mn=30000) and 0.31 g of technical tallowamine (Noram SH, CECA) are thoroughly mixed. The mixture is heated with powerful stirring to approx. 155° C., until a homogenuous solution is formed. The material is left cooling as in example 46.

Example 50 69 g of commercial sulfentrazone (92.4%) and 31 g of cellulose acetate butyroate (Mn=12000) are mixed and heated to 155° C. The mixture is stirred with a strong stirrer and continuous heating, until a homogeneous, transparent solution is formed. The material is left cooling as in example 46.

Example 51 69 g of commercial sulfentrazone (92.4%) and 31 g of cellulose acetate butyroate (Mn=70000) are mixed and heated to 155° C. The mixture is stirred with a strong stirrer and continuous heating, until a homogeneous, transparent solution is formed. The material is left cooling as in example 46.

Example 52 14 g of commercial sulfentrazone (92.4%) and 2.5 g of cellulose acetate butyroate (Mn=12000) are mixed and heated to 155° C. The mixture is stirred with a strong stirrer and continuous heating, until a homogeneous, transparent solution is formed. The material is left cooling.

Example 53 9.2 g of commercial sulfentrazone (92.4%) are melted at 140° C. and subsequently left cooling to RT.

Example 54 : Preparation of a slow release formulation of sulfentrazone. 20.5 g of commercial sulfentrazone (92.4%), 12.4 g of cellulose acetate butyroate (Mn=12000) and 0.68 g of technical tallowamine (Noram SH, CECA) are dissolved in 100ml of dichloromethane. The solution is poured on a flat surface under an air stream and dried. The resulting film is transferred to an oven of 54° C., and further dried for 1 day.

Example 55: Preparation of sub-particles. 80 g of formulation 1b are broken to pieces and ground by milling for 1 s. The material is sieved and separated to size ranges of 0-350 m, 350-420 m, and above 420 m. Coarse particles are subjected to more grinding and sieving.

This procedure can be applied to all preparations from examples 46 to 54. Depending on the duration of release required, larger or smaller particle ranges are selected. It is understood, that for other desired release properties particles of another, appropriate size can be chosen.

Example 56: Formulation of herbicidic granules with film granules of Example 54. 16.8 g of kaoline and 16.8 g of Sipernat 505 (Evonik-Degussa) are placed in a mixer. 16.3 g of technical Clomazone (91.8%) are added in portions with intermediate mixing. When all Clomazone is added, care has to be taken that the material is homogenous and evenly distributed. This is called Mix A

Separately, 103.4 g of Penoxsulam and 396.7 g of kaolin are mixed in a tumble blender until the components are homogenous and even distributed. This is called Mix B

To finalise the granule mix, 40-50 g of Borresperse NA (Borregaard), 8-12 g of Supragil WP (Rhodia), 20-25 g of Polyvinylpyrrolidone, 25-27 g of Example Mix A, 18-20 g of Mix B and 3-3.5 g of the product of Example 54 are filled into a plastic bag. Kaolin is added to 1.00 kg. The compounds are mixed in the bag and filled into the tumble blender, where mixing is continued for 2 h. The mixture is transferred to a ribbon blender and 290 g of water is slowly added while mixing. Addition is started drop-wise and increased as the mix moistens. When the mixture is homogenous, it is transferred to a granulating machine and granules are prepared. The granules are dried at 54° C. to a water content of less than 1-2%. When this mixture is applied to a rice paddy at rates equivalent to between 75 to 250 g/ha sulfentrazone adequate crop safety and weed control are observed. The material may similarly be broadcast in turf or other crops to achieve local weed control.

Example 57: Recovery of fine material. The fines of Example 55 are heated to 133° C. until they are melted together. They may then be re-ground.

Example 58: Preparation of Imazapyr Zinc Complex. 249.7 g of Imazapyr are suspended in 21 of deionized water. 56.2 g of potassium hydroxide are dissolved with 80 ml of deionized water and added portionwise to the imazapyr suspension. The pH is then adjusted to 6 with 2.5M KOH and 2M HCl. 133.8 g of zinc chloride are dissolved with 200 ml of deionized water and added to the imazapyr solution with vigurous strirring with a strong mechanical stirrer. The mixture is made up to 31 and warmed for 1 h to 75° C. The precipitate is the filtered by suction, washed with 250 ml of methanol and dried at 60° C. for 15 h. A similar process can be applied to copper and manganese complexes of imazapyr.

Example 59: Preparation of a Mixture of Water Soluble Salts of plant nutrients. 33.1 g of ZnEDTA complex, 20.5 g of Mn(II)-EDTA complex, 6 g of molybdophosphoric acid, and 6.1 g of borax are combined and mortared to a fine powder.

Example 59: Formulation of Imazapyr Zinc Complex in Acetyl Cellulose. 10.23 g of imazapyr zinc complex, 32.3 g of cellulose acetate (Mn=30000), 4.8 g of the mixture of soluble salts, 8.2 g of methyl cellulose, and 4.8 g of finely powdered calcium sulfate are combined in a mixing device. 200 ml of a mixture of 1 part of methanol and 4 parts of dichloromethane are added and the mixture is thoroughly mixed using a mortar and pestle to achieve a homogeneous slurry. The slurry is dried while continuously stirred, until a powder or granular mixture is formed. The powder is dried at 54° C. for 12 h. Subsequently, the powder is sieved to a particle size between 50 μm and 450 μm. Bigger particles can be milled until they pass through the sieve, smaller particles can be used by adding a portion of above solvent mixture, drying and regrinding. Any other particle size can be achieved as well.

The procedure can be applied to other ratios of the components as well:

TABLE
composition of various Imazapyr formulations in %

| | | | | | |
|---|---|---|---|---|---|
| Zn(Imazapyr)₂ | 5.1 | 5.1 | 5.1 | 5.1 | 5.1 |
| cellulose acetate | 40.8 | 43.1 | 44.2 | 45.3 | 35.7 |
| methyl cellulose | 4.5 | 2.3 | 1.1 | 0.0 | 0.0 |
| soluble salts | 9.6 | 9.6 | 9.6 | 9.6 | 19.2 |
| Imazapyr | 7.5 | 7.5 | 7.5 | 7.5 | 7.5 |
| Zn(Imazapyr)₂ | 8.4 | 8.4 | 8.4 | 8.4 | 8.4 |
| cellulose acetate | 68.0 | 71.8 | 73.7 | 75.6 | 59.6 |
| methyl cellulose | 7.6 | 3.8 | 1.9 | 0.0 | 0.0 |
| soluble salts | 16.0 | 16.0 | 16.0 | 16.0 | 32.0 |
| total | 100.0 | 100.0 | 100.0 | 100.0 | 100.0 |

Example 60: Formulation of Imazapyr Zinc Complex in Acetyl Cellulose. Imazapyr zinc complex (see amounts in table below), is dissolved in dichloromethane and mixed with acetyl cellulose such that the acetyl cellulose is dissolved ca. 30-40 mL. Methylcellulose swollen with methanol (ca. 10 mL) is added and mixed to homogeneity. To the mixture is added finely powdered calcium sulfate, urea and zinc chloride and these are mixed using a mortar and pestle to achieve a homogeneous slurry. The slurry is dried while continuously stirred, until a powder or granular mixture is formed. The powder is dried at 54° C. for 12 h. Subsequently, the powder is sieved to a particle size between 50 μm and 450 μm.

| Component | Amount (g) | Amount (%) |
|---|---|---|
| Imazapyr_Zn | 5.3 | 27.9 |
| Acetyl cellulose | 9.5 | 49.7 |
| Methyl cellulose | 0.5 | 2.6 |
| CaSO4 | 2.2 | 11.5 |
| Urea | 0.8 | 4.2 |
| ZnCl2 | 0.8 | 4.2 |

Example 61: Testing of Imazapyr Zinc Complex in maize culture to determine effect on Striga control. Maize seeds carrying an ALS mutation rendering them resistant to ALS inhibitors like Imazapyr are treated with the product of example 60 to the equivalent of ca. 30 g per hectare imazapyr. The seeds are planted and the rate of emergence, the amount of weeds and the yield are observed and compared with untreated plants and plants treated with technical herbicide as the treatment. The product of example 60, when applied to seeds under conditions of significant Striga parasitism, provides for yield the same or greater than that observed for both the untreated plants and those treated with technical herbicide, emergence rates greater than those treated with the technical herbicide and weed numbers that are lower than those in the untreated plants.

### Other Embodiments

All of the features disclosed in this specification may be combined in any combination. Thus, unless expressly stated otherwise, each feature disclosed is only an example of a generic series of equivalent or similar features.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

### Abbreviations

The following abbreviations were used as noted:

MeOH: methanol

NaHCO₃: sodium bicarbonate

K₂CO₃: potassium carbonate

MS: mass spectrometry

DMSO: dimethyl sulfoxide

TLC: thinlayer chromatography

Et₃N: triethylamin

EtOAc: ethyl acetate

DCM: dichloromethane

NH₄Cl: ammonium chloride

THF: tetrahydrofurane

Na₂CO₃: sodium carbonate

EDCI: N-Ethyl-N′-(3-dimethylaminopropyl)carbodiimide hydrochloride

DMAP: 4-dimethylamino pyridine

### Citation List Patent Literature

US patent literature

| | |
|---|---|
| U.S. Pat. No. 5,532,209 | Propanil dispersible granule formulation, |
| U.S. Pat. No. 5,597,777 | Oxyfluorfen dispersible granule formulation, |
| U.S. patent application | Multicompartment granulate formulations for |
| 20090317468 | active substances, |
| U.S. Pat. No. 36,172 | Pesticide granules and method of preparing |
| | such granules, 46 |
| U.S. Pat. No. 6,486,095 | Agricultural chemicals formulation for rice |
| | paddy field, preparation thereof and the |
| | method for scattering the same |
| U.S. patent application | Granular compositions |
| 20120142534 | |
| Japanese Patent | Granulated formulation of agricultural |
| JP08092004 | chemical |
| Japanese Patent | Granule formulation for controlling soil |
| JP2011148723 | disease injury and method for controlling soil |
| | disease injury |
| Japanese Patent | Agrochemical solid formulation for paddy |
| JP07145001 | field |

### CITATIONS

### Non Patent Literature

The entire contents of all patents published patent applications and other references cited herein are hereby expressly incorporated herein in their entireties by reference.

Those skilled in the art will recognize, or be able to ascertain using no more than routine experimentation, numerous equivalents to the specific procedures described herein. Such equivalents are considered to be within the scope of this invention and are covered by the following claims.

1: A method of controlling weeds in crops or turf comprising contacting the crop or turf with a composition containing herbicide wherein the herbicide is retained in a sub-particle within a granule such that 40% or more is not available within 24 h in a “Standing paddy system” extraction assay.

2: (canceled)

3: (canceled)

4: (canceled)

5: (canceled)

6: (canceled)

7: The method of controlling weeds as in claim 1 wherein the herbicide is selected from sulfentrazone, clomazone, carfentrazone, propanil, triketones herbicides, HPPD inhibitor herbicides, ALS inhibitor herbicides, phytoene desaturase inhibitor herbicides, triazine herbicides, dinitroaniline herbicides, chloracetanilide herbicides, bleaching herbicides, photosystem inhibitor herbicides, pigment formation inhibitor herbicides, pyrimidinylsulfonylurea herbicides, pyrimidinyloxybenzoic acid herbicides, triazolone herbicides, sulfonamide herbicides, phenylureas herbicides, auxin herbicides, aryloxyphenoxypropionate herbicides, cyclohexanedione herbicides, benzofuranyl alkylsulfonate herbicides, pyrazole herbicides, thiocarbamate herbicides, tetrazolinone herbicides, inhibitors of very long chain fatty acid synthesis, amide herbicides, respiration inhibitor herbicides, sterol synthesis inhibitor herbicides, organophosphate herbicides, organochloride herbicides, or a sulfonylurea herbicide.

8: The method of controlling weeds as in claim 1 wherein the herbicide is selected from sulfentrazone, clomazone, carfentrazone, or a sulfonylurea herbicide.

9: (canceled)

10: The method of controlling weeds as in claim 1 wherein sub-particle or granule comprises a polymer selected from: particles cellulose, and a derivative of the cellulose is selected from the group consisting of cellulose acetate butyrate, hydroxypropyl methyl cellulose, hydroxypropyl cellulose, methyl cellulose, ethyl cellulose, cellulose acetate, and nitrocellulose, chitosan, polyethyleneimine, octadecylamine,cellulose acetate butyrate, octadecylamine, stearic acid, methyl cellulose, hydroxypropyl methyl cellulose, hydroxypropyl cellulose, gelatin, polystyrene, latex, ethyl cellulose, polyvinylene, polystyrene, cellulose acetate, polyvinyl alcohol, poly(methyl methacrylate), polyvinyl acetate, polyvinylchloride, hypromellose, nitrocellulose, polycaprolactone, polylactide, polyethylene glycol, starch, polypropylene glycol, polyacrylates, polyethylene imines, polyvinyl amines, fatty acids with at least 6 carbon atoms, alkyl amines, chitin, chitosan, lignin, proteins, resins comprising dammar, colophony, olibanum (frankincense), myrrh, galipot, rosin; paraffin waxes, and polyhydroxybutyrate.

11: (canceled)

12: The method of controlling weeds as in claim 8 wherein the sub-particle or granule contains a polymer selected from: a derivative of the cellulose.

13: A composition containing sulfentrazone in which sulfentrazone is present between 0.1 and 98% in a solid matrix sub-particle and that less than 50% of the sulfentrazone is released from the matrix when it is incubated in the “Standing paddy system” extraction assay.

14: (canceled)

15: (canceled)

16: (canceled)

17: The composition as in claim 13 in which the solid matrix is milled to a mean particle size less than 50 μm.

18: (canceled)

19: The composition as in claim 13 in which the solid matrix is milled to a mean particle size between 1000 and 30 μm and is mixed with inert ingredients, surfactants and other herbicides and extruded or agglomerated into a granule.

20: (canceled)

21: The composition as in claim 19 in which the other herbicides are selected from clomazone, carfentrazone, propanil, or ALS inhibitor herbicides.

22: (canceled)

23: (canceled)

24: (canceled)

25: The composition as in claim 19 in which the inert ingredients are capable of forming a gas in the presence of water.

26: (canceled)

27: (canceled)

28: The composition as in claim 13 in which the solid matrix contains a water soluble salt, substance or polymer that is not a pesticide in addition to sulfentrazone and the matrix material and is present up to 30% of the composition by dry weight.

29: (canceled)

30: (canceled)

31: The composition as in claim 13 in which the solid matrix contains a water soluble salt, substance or polymer that is selected from a plant micronutrient, a plant macro nutrient, or a water soluble polymer.

32: The composition as in claim 13 in which the solid matrix contains a water soluble salt, substance or polymer that is selected from a urea, CaSO4, ammonium sulfate, sodium phosphate, potassium phosphate, calcium carbonate, zinc chloride, a mixture of plant micronutrient salts.

33: A method of controlling weeds in a crop using a composition as in claim 13 in which the solid matrix is ground to a size range such that it may be sprayed by conventional means and such that less than 30% of the active ingredient leaves the matrix before it is applied to the crop.

33: (canceled)

34: The composition as in claim 33 in which particles are mixed with a sulfonylurea herbicide.

35: The composition as in claim 19 in which the inert ingredients are capable of forming a foam in the presence of water, and in which the foam is stable for more than 1 h.

36: The composition as in claim 1 in which each of the herbicides is carfentrazone, sulfentrazone, and clomazone are present.

37: (canceled)

38: (canceled)

39: The method as in claim 1 in which a herbicide is sulfentrazone, the crop is rice, wheat, or soybean, and less than 200 g/ha sulfentrazone is used in a single application.

40: (canceled)

41: (canceled)

42: (canceled)

43: (canceled)

44: (canceled)

45: (canceled)

46: (canceled)

47: (canceled)

48: (canceled)

49: (canceled)

50: (canceled)

51: (canceled)

52: (canceled)

53: (canceled)

54: (canceled)

55: The method as in claim 1 in which the herbicide is sulfentrazone, the crop is turf, and less than 400 g/ha sulfentrazone is used in a single application.

56: A composition which is a granule comprising a subparticle containing an ALS inhibitor in the range 0.1 to 40% by dry weight.

57: (canceled)

58: (canceled)

59: (canceled)

60: The composition as in claim 8 in which the herbicide is carfentrazone.
